(19) United States
(12) Patent Application Publication
(10) Pub. No.: US 2004/0205600 A1
(43) Pub. Date: Oct. 14, 2004

(54) INFORMATION FRAGMENTS EDITING SYSTEM AND COMPUTER MEMORY PRODUCT

(75) Inventors: JUN KAKUTA, KAWASAKI-SHI (JP); TOSHIHIRO AZAMI, KAWASAKI-SHI (JP); SOUICHI OKADA, KAWASAKI-SHI (JP); SATORU WATANABE, KAWASAKI-SHI (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 08/764,560

(22) Filed: Dec. 12, 1996

(30) Foreign Application Priority Data
Mar. 5, 1996 (JP) 8-047723

(51) Int. Cl. G06F 15/00

(52) U.S. Cl. 715/516

(57) ABSTRACT

An information fragments editing system for getting information fragments from a variety of application programs to treat the obtained information with a direct method, such as movement, relation making, combination and separation by a mouse. The system has a function for storing the contents and attribute information of an information object to be shown, a function for showing the information object on a window in accordance with the stored information, a function for transmitting a control message to an external application program, a function for analyzing an event and a function for performing at least one of processes including a process for controlling the stored information, a process for controlling transmission of the control message to an external application program and a process for controlling drawing in such a manner that the information object is shown, in accordance with a result of analysis. When any information item in an external application program has been selected and an input event for obtaining the selected information has been analyzed, the selected information above is created as an information object to show the information object on the window.

### BACKGROUND OF THE INVENTION

1. Field of the Invention

The present invention relates to an editing system for obtaining, by cutting, a portion of information controlled by an external application program, such as word processor, and showing the obtained information so as to edit these one or more information fragments directly, such as moving information fragments, making relation between information fragments, combining with other information fragment and separating an information fragment into two ones.

2. Description of Related Art

As a system for writing a document, a word processor has been known as a general. However, the word processor is adapted to an edition method in which the edition is performed in character units and certain information fragments cannot be treated as an aggregation. Thus, the word processor is not effective in every field.

A conventional art relating to the present invention has been known, which is a “document input/retrieval apparatus” (refer to Japanese Patent Application Laid-Open No. 2-170266 (1990)) having a structure such that a memo (a tag), on which information has been written, is overlaid on a document written by a word processor. The foregoing application program has an arrangement such that the body of the document and a tag indicating the contents of information and the position at which the information item is displayed are separably controlled, and the tag is inserted into the document.

An “information processing apparatus” capable of displaying objects, such as documents, in the form of icons has been disclosed (refer to Japanese Patent Application Laid-Open No. 4-51337 (1992)) in which a memo (a tag) relating to an object is overlaid on the object so that objects (documents) are efficiently controlled.

Hitherto, a computer system for supporting, for example, a conference which many persons attend, and in which they present ideas has been developed. However, the system has been realized by simple word processors each of which is capable of editing a text or a dedicated application program. However, the word processor cannot easily categorize various kinds of information, separate information which is out of context and independent in terms of meaning and combine a certain information item with another information item. If a conference is supported by using a dedicated application program, there are difficulties to use the edited information later.

### SUMMARY OF THE INVENTION

An object of the present invention is to provide an information fragments editing system for getting information fragments from a variety of application programs to edit these information in a direct way, such as moving information fragments, making relation between information fragments, combining with other information fragment and separate an information fragment into two ones.

Another object of the present invention is to provide an information fragments editing system capable of editing information efficiently and creating a final version of document easily by executing aforementioned method for a meaningful unit.

Another object of the present invention is to provide an information fragments editing system capable of finally inserting contents of edited information fragment into an application program and easily reusing the created information.

Another object of the present invention is to provide a computer memory product having a computer program recorded therein and capable of realizing the foregoing information presentation system.

FIG. 1 is a block diagram of a system according to the present invention. The system according to the present invention and connected to an operation system 8 comprises information storing means 1, drawing means 2, event analyzing means 3, message transmitting means 4, contents displaying means 5 and application executing means 6. Reference numeral 7 represents an external application program.

The information storing means 1 stores/controls object ID, object type (master object attribute, slave object attribute, group attribute and so on), type of information (text, bitmap, file and so on), priority, time stamp, contents, object ID of link-destination object, the object ID of a next object and the like for each information object. The drawing means 2 displays required information objects on a window in accordance with information stored in the information storing means 1.

The event analyzing means 3 analyzes an input event occurred by a user to the application program or acquires a message event issued from the operation system to acquire name of the application program which has been active at an immediately previous moment in accordance with the parameter of the message event. Then, the event analyzing means 3 notifies the application executing means 6 of a supplementary parameter for an issued or required command or, if necessary, name of the application program.

The message transmitting means 4 transmits a command/a message for controlling an external application program, for example a word processor. The contents displaying means 5 gets detailed information in the information storing means 1 in accordance with the information object ID notified from the event analyzing means 3 to display the contents. When it acquires an event from a user, such as input, change or separation, it notifies the application executing means 6 of the changed contents.

The application executing means 6 creates a window for displaying an information object, and uses a command and a parameter notified from the event analyzing means 3 to cause the information storing means 1 to create a new information object or change the contents of an existing information object or to cause the message transmitting means 4 to control an external program or to cause the drawing means 2 to draw an information object.

The information fragments editing system according to a first aspect of the present invention is an information fragments editing system to execute an application program that is acquiring information fragment from an external application program and displaying the acquired information as an information object and comprises information storing means 1 for storing contents and attribute of an information object to be displayed; drawing means 2 for displaying the information object on a window in accordance with the contents and attribute stored in the information storing means 1; message transmitting means 4 for transmitting a control message to an external application program; event analyzing means 3 for analyzing an event and reporting a result of the analysis; and application executing means 6 for executing at least any one of processes including a process of controlling the operation of the information storing means 1 for storing the contents and attribute information of the information object, the operation of the message transmitting means 4 for transmitting the control message to an external application program and the operation of the drawing means 2 for displaying the information object, in accordance with the result of the analysis reported from the event analyzing means 3; wherein in a case where arbitrary information in an external application program has been selected and the event analyzing means 3 has reported an event for obtaining the selected information, an information object is created, which has the same contents as that of the selected information, so as to be displayed on the window by the drawing means 2.

In the first aspect of the present invention, in case that information in an external application program of a word processor is selected which is independent from the application in this system and a user event for acquiring information has been generated, the event analyzing means 3 analyzes the event to notify the application executing means 6 of the information object creation command and the name of the external application program from which the information has been acquired. For example, the event analyzing means 3 inspects a message from an operation system to acquire the name of the external application program in accordance with the ID of the external application program which has been active at the immediately previous moment.

The application executing means 6 instructs the message transmitting means 4 to issue a command for causing the external application program to copy information on the selected portion. The application executing means 6 records, to an object table existing in the information storing means 1, required information to be stored including the contents obtained from the external application program, the type of the information object, the type of information, the date and time of creation, object ID, the coordinates for displaying the information object, object ID of the linked information object and the object ID of the next information object. Moreover, the application executing means 6 writes its own object ID into item “next object ID” of the last information object in the object table.

The application executing means 6 makes the drawing means 2 display the information object stored in the information storing means 1. The drawing means 2 retrieves information for drawing from the object table in the information storing means 1 and displays the contents of the information object which should be drawn until the final information object appears in the object table. For example, it surrounds the contents by a rectangular frame to display the contents on the window.

As described above, an information fragment can be acquired from any external application program and the contents of the information can be displayed and controlled as one information object.

An information fragments editing system according to a second aspect of the present invention accords to the first aspect and is structured so as to insert contents of the selected information object into the original external application program from which the information object has been obtained.

According to the second aspect of the present invention, when an information object has been selected by a user and an information object insert command has been generated, the event analyzing means 3 analyzes an event to notify the application executing means 6 of the object insert command and the object ID for identifying the information object. The application executing means 6 retrieves information for drawing from the object table in the information storing means 1 in accordance with the notified object ID to acquire the contents and the name of the application program from which information has been acquired. Moreover, the application executing means 6 stores the contents in a temporal buffer and makes the message transmitting means 4 transmit a message for causing the application program to copy the contents in the buffer.

After the message has been transmitted, the application executing means 6 removes information on the information object from the object table and makes the drawing means 2 clear the area where the object has occupied in the window. Moreover, if there is an information object which refers to this removed object as the next object, the value of the object ID is replaced by the value of the next object ID of the removed object. The drawing means 2 overwrites the region which the information object has occupied with empty contents to clear the area.

As described above, an information object temporarily acquired from an external application program or an information object formed by editing the acquired information object can be inserted into the original external application program from which the information object has been supplied.

An information fragments editing system according to a third aspect of the present invention accords to the first aspect and is structured so as to insert contents of the selected object into a specified external application program which is different from the original external application program from which the information object has been obtained.

A third aspect of the present invention is structured such that, when an information object has been selected by a user and an object transference command in which the application program to which the object is transferred is specified has been generated, the event analyzing means 3 analyzes an event and notifies the application executing means 6 of the object transference command, the object ID for identifying the information object and the name of the application program to which the object is transferred. The application executing means 6 retrieves information for drawing from the object table in the information storing means 1 in accordance with the notified object ID to acquire the contents of the information object. Moreover, the application executing means 6 stores the contents in the temporary buffer and makes the message transmitting means 4 issue a message to copy the contents of the buffer to the notified application program.

After the message has been issued, the application executing means 6 removes information of the information object from the object table and makes the drawing means 2 clear the area where the object has occupied in the window. Moreover, if there is an information object which refers to the removed object as the next object, the value of the object ID is replaced by the value of the next object ID of the removed object. The drawing means 2 overwrites the region which the information object has occupied with empty contents to clear the area.

As described above, the acquired information object or an information object formed by editing the acquired information object can be transferred to other application program which is different from the original application program from which the information object has been supplied.

An information fragments editing system according to a fourth aspect of the present invention accords to the first aspect and is structured so as to select an information object and move it on the window.

According to the fourth aspect of the present invention, in a case where an information object has been selected by a user and an object movement event has been generated, the event analyzing means 3 analyzes an event to notify the application executing means 6 of the object movement command, the object ID and the amount of movement. The application executing means 6 retrieves information for drawing from the object table in the information storing means 1 in accordance with the notified object ID and uses the notified amount of movement to recalculate the location for displaying the information object in the object table, and update the values of the location of the object in the object table.

The application executing means 6 makes the drawing means 2 display a required information object stored in the information storing means 1. The drawing means 2 overwrites the region, where the information object has occupied, with empty contents to clear the area. Then, the drawing means 2 displays the contents at an updated location in such a manner that the contents are surrounded by a rectangle.

As described above, the information object can be moved to an arbitrary position on the window so that it is shown at the new position.

An information fragments editing system according to a fifth aspect of the present invention accords the first aspect and is structured so as to remove attribute information of selected object stored in the information storing means 1, and delete the area where the object has occupied.

In the fifth aspect, in a case where an information object has been selected by a user and an object deletion command has been generated, the event analyzing means 3 analyzes an event to notify the application executing means 6 of the object deletion command and the information object ID. The application executing means 6 retrieves information for drawing from the object table in the information storing means 1 in accordance with the notified object ID to remove information of the information object from the object table.

If there is an information object which refers to the selected information object as a next information, the value of the object ID is updated by the value of the “next object ID” of the selected object. Moreover, the application executing means 6 makes the drawing means 2 remove the area where the object has occupied display of the information object. The drawing means 2 overwrites the region, in which the information object has existed, with empty contents to clear the display.

As described above, an unnecessary information object can be deleted at any time.

An information fragments editing system according to a sixth aspect of the present invention accords the first aspect and is structured so as to change the contents of the selected information object and show the object that has the changed contents.

According to the sixth aspect, in a case where an information object has been selected by a user and an object change command has been generated, the event analyzing means 3 analyzes an event and notifies the contents displaying means 5 of the object change command and the information object ID. The contents displaying means 5 retrieves information for drawing from the information storing means 1 to acquire the contents of the information object, and then accepts change of the contents from the user and goes to a waiting state.

When the user has changed the contents and issued a contents change completion notification, the contents displaying means 5 notifies the application executing means 6 of the object change command, the object ID and the changed contents. The application executing means 6 retrieves information for drawing from the object table in the information storing means 1 in accordance with the notified object ID to replace the contents of the changed information object with a new contents and also update other information, such as the date and time of creation.

Moreover, the application executing means 6 makes the drawing means 2 show information objects to be redrawn stored in the information storing means 1. The drawing means 2 retrieves information for drawing from the object table to display the contents of the objects which must be drawn until the final information object appears in the object table, in such a manner that the contents are surrounded by a rectangle.

As described above, the contents of the information object can be changed at any time.

An information fragments editing system according to a seventh aspect of the present invention accords to the first aspect and is structured so as to make a new information object which is related to existing information object in accordance with an external input.

According to the seventh aspect, when an information object has been selected by a user and a command for adding information relating to the existing object has been generated, the event analyzing means 3 analyzes an event to notify the contents displaying means 5 of the command for adding related information and information object ID. The contents displaying means 5 retrieves information for drawing from the information storing means 1 to display empty contents on the window and accepts an input of the contents by the user, and then goes to a waiting state.

When the user has inputted the contents and issued a content input completion notification, the contents displaying means 5 notifies the application executing means 6 of the related object creation command, the object ID and the inputted contents. The application executing means 6 records information of the related object in the object table in the information storing means 1 as a new information object. The item of the object type for a new created object is set to “slave information object” and the date and time is also set to an appropriate value, and the item of “linked object ID” is set to the new created object ID. Moreover, the application executing means 6 writes the newly created object ID to the item “next object ID” of the final information object at the top level.

Moreover, the application executing means 6 makes the drawing means 2 display information objects stored in the information storing means 1. The drawing means 2 retrieves information for drawing from the object table to display the contents which must be drawn until the final information object appears in the object table in such a manner that the contents are surrounded by a rectangle.

As described above, any information object related to an existing information object can be created as a new information object.

An information fragments editing system according to an eighth aspect of the present invention accords to a first aspect and is structured so as to combine an information object with another, and display the information object which contents of an object are appended to other.

According to the eighth aspect, when information objects have been selected by a user and a command for combining contents of the selected information objects with each other has been generated, the event analyzing means 3 analyzes an event and notifies the application executing means 6 of the object combining command, the combining object ID and the combined object ID. The application executing means 6 retrieves information for drawing from the object table in the information storing means 1 in accordance with the notified combining object ID to acquire the contents of the relevant information object. In accordance with the combined object ID, it acquires the contents of the information object to append the combining contents to the combined contents.

Moreover, the application executing means 6 modifies the item of the date and time of creation of the combined object in the object table and removes all information about the combining object from the object table. If there is an information object which refers to the combining information object as a next information object exists, the value of the “next information object” is replaced by the value of the next object ID of the combining object. Moreover, the application executing means 6 makes the drawing means 2 display information objects to be drawn stored in the information storing means 1. The drawing means 2 retrieves information for drawing from the object table and display the contents of the information object which must be drawn until the final information object appears in the object table in such a manner that the contents are surrounded by a rectangle.

As described above, one information object which has the combined contents can be created by combining two arbitrary information objects.

An information fragments editing system according to a ninth aspect of the present invention accords to the first aspect and is structured so as to separate contents of the selected information object into two information objects, and show these two objects on a window.

According to the ninth aspect, when an information object has been selected by a user and a command for separating the contents of the information object has been generated, the event analyzing means 3 analyzes an event to notify the contents displaying means 5 of the object separation command and the object ID. The contents displaying means 5 retrieves information for drawing from the information storing means 1 to acquire the contents of the relevant information object to display the contents and accepts separation of the contents from the user. Then, there goes to a waiting state.

When a user has separated the contents into two objects and issued a content separation completion notification, the contents displaying means 5 notifies the application executing means 6 of the object separation command, the object ID, the first contents and the second contents. The application executing means 6 retrieves information for drawing from the object table in the information storing means 1 in accordance with the notified object ID to replace the contents of the information object with partly removed contents from the original. The application executing means 6 also updates information, such as the date and time of creation, necessary to be changed. Moreover, the contents removed from the original are registered into the information storing means 1 as a new information object. Then, the information object ID is written to the item “next object ID” of the final information object at the top level.

Moreover, the application executing means 6 makes the drawing means 2 display the information objects stored in the information storing means 1. The drawing means 2 retrieves information for drawing from the object table to display the contents which must be drawn until the final information object appears in the object table in such a manner that the contents are surrounded by a rectangle.

As described above, an arbitrary information object can be separated into two information objects.

An information fragments editing system according to a tenth aspect of the present invention accords to the first aspect and is structured so as to control selected information object as one information object group.

According to the tenth aspect, when information objects have been selected by a user and an object relating command has been generated, the event analyzing means 3 analyzes an event to notify the application executing means 6 of an object relating command, the object ID of either of a first information object and the object ID of a second information object.

The application executing means 6 retrieves information for drawing from the object table in the information storing means 1 in accordance with the object ID of the notified first information object, and then sets the object ID of the notified second information object to the item “linked object ID” of the first information object. Moreover, the application executing means 6 sets the group attribute to the type of the object. Moreover, it inspects whether or not the second information object has the related object. If it has the related object, it sets the first information object ID to the item of the “next object ID” of the last related object.

If the second information object has not the related object, it sets the first information object ID to the item of the “linked object ID” of the second information object. Moreover, the group attribute is set to the type of the object. As a result, the first information object can be related to the second information object.

As described above, any information objects can be grouped.

An information fragments editing system according to an eleventh aspect of the present invention accords to the tenth aspect and is structured so as to move information object group in the way how the location of all objects in the group is maintained relatively when an information object in a group is selected and moved by a user.

According to the eleventh aspect, when an information object with a related information object has been selected and an event for moving the information object has been generated, the event analyzing means 3 analyzes an event to notify the application executing means 6 of the object movement event, the object ID and the amount of movement. The application executing means 6 retrieves information for drawing from the object table in the information storing means 1 in accordance with the notified object ID to recalculate the location of the objects and update the location. Moreover, the application executing means 6 retrieves the item “next object ID” from the object table so as to calculate and update the location of all the related objects in order to maintain the relative location among the objects.

Moreover, the application executing means 6 makes the drawing means 2 display required information objects stored in the information storing means 1. The drawing means 2 retrieves information for drawing from the object table to display the contents which must be drawn until the final information object appears in the object table in such a manner that the contents are surrounded by a rectangle.

As described above, related information objects (grouped information objects) can be moved maintaining the relative location on the window among themselves.

An information fragments editing system according to a twelfth aspect of the present invention accords to the tenth aspect and is structured so as to delete all the information objects in object group when an information object group has been selected and deleted.

According to the twelfth aspect, when an information object with a related information object has been selected and a command for deleting the information object has been generated, the event analyzing means 3 analyzes an event and notifies the application executing means 6 of the object deletion command and the object ID. The application executing means 6 retrieves information for drawing from the object table in the information storing means 1 in accordance with the notified object ID, and then removes all the information of the information object from the object table for the information object.

Moreover, if there is an information object which refers to the removed information object as the next information object, the next object ID is replaced with the value of the next object ID of the removed information object. Moreover, the application executing means 6 repeats a similar process for all related information objects by retrieving information from the object table.

Moreover, the application executing means 6 makes the drawing means 2 clear the area where the object group has occupied. The drawing means 2 overwrites a region in which the information object and all of the related information objects have existed with empty contents to clear the region.

As described above, the related information objects (grouped information objects) can be deleted.

An information fragments editing system according to a thirteenth aspect of the present invention accords to the tenth aspect and is structured so as to cancel the relationship which the selected information object belongs to.

According to the thirteenth aspect, when an information object has been selected by a user and a command for canceling the relationship of the information object groups has been generated, the event analyzing means 3 analyzes an event and notifies the application executing means 6 of an object relationship canceling command and the selected object ID. The application executing means 6 retrieves information for drawing from the object table of the information storing means 1 with the notified object ID, and clears the “group attribute” of the item “type of object” of the relevant information object. Moreover, the application executing means 6 clears the group attribute of the item of the object type of all the information objects by using the item of their next object ID in the object table.

As described above, the relationship (the grouped relationship) which has been once established can be canceled at any time.

An information fragments editing system according to a fourteenth aspect of the present invention accords to the tenth aspect and is structured so as to give the two selected information objects a hierarchical relationship, that is, one is the master and the other is the slave.

According to the fourteenth aspect, when two information objects have been selected by a user and a command for setting the hierarchical relationship between the information objects has been generated, the event analyzing means 3 analyzes an event and notifies the application executing means 6 of the command for giving the hierarchical relationship, the object ID of the slave information object (a first information object) and the object ID of the master information object (a second information object).

The application executing means 6 retrieves information for drawing from the object table in the information storing means 1 in accordance with the notified object ID of the slave object, to set the notified object ID of the master object to the item “linked information object” of the slave object. Moreover, the application executing means 6 sets “slave attribute” to the item of the “type of object” of the slave object. Moreover, the application executing means 6 inspects whether the master object already has other slave objects. If it has other slave information object, the application executing means 6 sets the object ID of the notified slave object to the item of the “next object ID” of the last slave object.

If the master object doesn't have other slave information object, the application executing means 6 sets the object ID of the slave object to the item of “linked object” of itself, and “master information object” to the “type of object” of the master object. As a result, the information object above can be related to the other information object with a hierarchical relationship.

Moreover, the location of the slave information object to be displayed is calculated appropriately and updated in such a manner that the slave information object is located near the master information object.

As described above, two information objects can be related to each other with a hierarchical relationship.

An information fragments editing system according to a fifteenth aspect of the present invention accords to the fourteenth aspect and is structured so as to remove the related information object with a hierarchical relationship when information object with the relationship is selected and removed.

According to the fifteenth aspect, when an information object having an information object with the hierarchical relationship has been selected by a user and a command for deleting the information object has been generated, the event analyzing means 3 analyzes an event and notifies the application executing means 6 of the object with hierarchical deletion command and the selected object ID. The application executing means 6 retrieves information for drawing from the object table in the information storing means 1 in accordance with the notified object ID to acquire the type of its information object.

In case that the selected information object has the slave attribute and master information object for the object does not have other slave information objects, information on the selected information object is cleared. Moreover, the item of the type of the object of the master information object for the selected object and the item of the “linked object ID” are cleared. In case that the master information object for the selected object has other slave information objects, information of the selected information object is cleared and the item “next object ID” of the information object which refers to the selected object as a next object is set to the item “next object ID” of the selected information object.

If the selected information object has the attribute of “master information object”, information of the selected information object is cleared and all the items of “type of object” and “linked object ID” of the objects which are the direct slave of the selected information object. Moreover, if there is an information object which refers to the selected information object as a next object, the item “next object ID” of the information object is set to the value of the item “next object ID” of the selected information object.

Moreover, the application executing means 6 notifies the drawing means 2 of removing the selected information object. The drawing means 2 overwrites the region, where the selected information object has existed, with empty contents to clear the area.

As described above, the master information object or the slave information object with a hierarchical relationship can selectively be deleted.

An information fragments editing system according to a sixteenth aspect of the present invention accords to the tenth aspect and is structured so as to show an information object in a different way whether it belongs to a certain information object group or not.

According to the sixteenth aspect, if an information object has related information objects, the drawing means 2 shows the information object on the window, with different background color of a rectangular region around the information object and different font of the contents from those of information objects which don't have the related information objects.

As described above, an information object which has related information object and an information object which has no related information object are shown in a different way so as to be distinguished clearly.

In the first aspect, when information objects are displayed on the window, only information objects satisfying a specific conditions are displayed. In a case where the drawing means 2 displays an information object on the window, it uses information stored in the information storing means 1 to display the only information objects satisfying predetermined conditions. The conditions for showing information objects include, for example, to show the latest 10 information objects and to show only master information object. As described above, only information objects satisfying conditions required by a user can selectively be displayed.

In the first aspect, when information objects are shown on the window, the information objects are arranged and shown in a specific order. In case that a command to rearrange the information objects has been generated by a user, the event analyzing means 3 analyzes an event to notify the application executing means 6 of an information object rearranging command. The application executing means 6 notifies the drawing means 2 of a command to rearrange the information objects. The drawing means 2 arranges the information objects from upper left side of the window using attribute information stored in the object table in the information storing means 1. The arrangement may be performed in the order of the date and time of the object from the latest one creation. Thus, information objects can be arranged in an order required by a user so as to be displayed on a window.

In the first aspect, a file on a storage medium is selected and the selected file is shown as an information object. In a case where a command for creating file information object has been generated by a user, the event analyzing means 3 analyzes an event to notify the application executing means 6 of the command for file object creation and its file name. The application executing means 6 sets the “file attribute” to the item of the “type of object information” of the object in the object table, sets the file name to the contents and sets the date and time of creation and the location to be shown. Moreover, the application executing means 6 makes the drawing means 2 show the created file information object. The drawing means 2 displays the information object on the window. As described above, a file can be shown on a window as an information object.

Moreover, the structure is formed in such a manner that the contents of the selected file are displayed. In a case where an information object with a file attribute has been selected by a user and an event for opening the file information object has been generated, the event analyzing means 3 analyzes an event to notify the application executing means 6 of the file object open command and the object ID. The application executing means 6 retrieves information for drawing from the object table in the information storing means 1 to acquire the file name of the information object so as to open the file with other application program. As described above, the contents of the file, which has been formed as an information object, can be shown.

In the first aspect, the contents of all the information objects are stored in files on a storage medium. In a case where an event for storing objects has been generated by a user, the event analyzing means 3 analyzes an event to notify the application executing means 6 of an object storing command. The application executing means 6 stores information of all the information objects in the object table of the information storing means 1 in the file on the storage medium. As described above, a created file information object can be stored at any time.

Moreover, the structure is constituted so as to restore the information object on the window by retrieving information for drawing from the file. In case that an event for restoring information objects has been generated by a user, the event analyzing means 3 analyzes an event to notify the application executing means 6 of the object restoring command and name of the file storing information of the information objects. The application executing means 6 loads information for drawing from the file in accordance with the notified file name to restore all the information objects into the object table of the information storing means 1. The application executing means 6 makes the drawing means 2 show all the information objects. The drawing means 2 shows the contents of each information object in such a manner that the contents are surrounded by a rectangle. As described above, the stored information object can be retrieved from the file at any time so as to be shown on the window again.

Moreover, the computer memory product according to the present invention has a computer program recorded therein, the computer program being arranged to execute the process of the above-mentioned information presentation system.

The above and further objects and features of the invention will more fully be apparent from the following detailed description with accompanying drawings.

### BRIEF DESCRIPTION OF THE DRAWINGS

FIG. 1 is a block diagram showing a system according to the present invention;

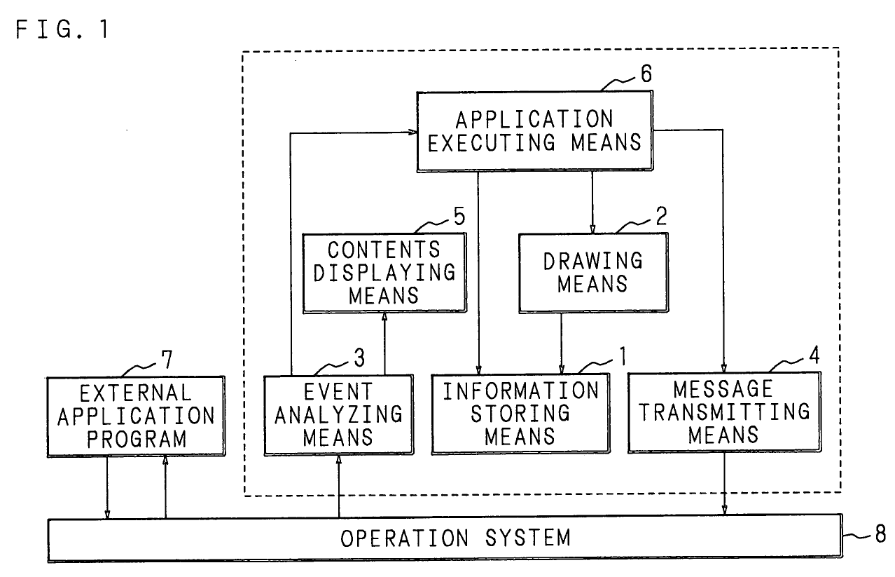

FIG. 2 is a schematic view showing the structure of an embodiment of the present invention;

FIG. 3 is a block diagram showing the structure of the embodiment of the present invention;

FIG. 4 is a schematic view showing an initial screen when the system according to the present invention has been turned on;

FIG. 5 is a schematic view showing a screen when the system according to the present invention is being operated (when an information object is being created);

FIG. 6 is a schematic view showing a screen when the system according to the present invention is being operated (in a state where input of an operation and selection of an information object is waited for);

FIG. 7 is a schematic view showing a screen when the system according to the present invention is being operated (a requirement for editing the contents of an information object);

FIG. 8 is a schematic view showing a screen when the system according to the present invention is being operated (a requirement for related information of an information object);

FIG. 9 is a schematic view showing a screen when the system according to the present invention is being operated (a requirement for displaying conditions of an information object);

FIG. 10 is a schematic view showing a screen when the system according to the present invention is being operated (a requirement for rearranging conditions for an information object);

FIG. 11 is a schematic view showing a screen when the system according to the present invention is being operated (a requirement for inputting the name of a file formed into an object);

FIG. 12 is a schematic view showing a screen when the system according to the present invention is being operated (display of a file formed into an object);

FIG. 13 is a schematic view showing a screen when the system according to the present invention is being operated (a requirement for storage of an object);

FIG. 14 is a diagram showing a portion (creation of an information object) of a sequence of the system according to the present invention;

FIG. 15 is a diagram showing another portion (movement, deletion and return of an information object) of the sequence of the system according to the present invention;

FIG. 16 is a diagram showing another portion (edition of an information object) of the sequence of the system according to the present invention;

FIG. 17 is a diagram showing another portion (grouping and link making of an information object) of the sequence of the system according to the present invention;

FIG. 18 is a diagram showing another portion (rearranging, selectively showing and file opening of an information object) of the sequence of the system according to the present invention;

FIG. 19 is a schematic view showing another embodiment of the present invention; and

FIG. 20 is a block diagram showing another embodiment of the present invention.

### DESCRIPTION OF THE PREFERRED EMBODIMENTS

Preferred embodiments of the present invention will now be described with reference to the drawings.

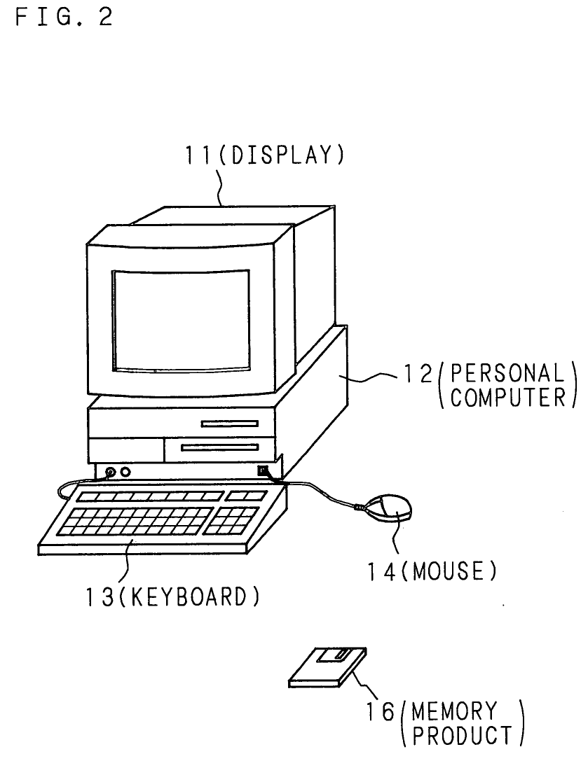

FIG. 2 is a schematic view showing the basic structure of a first embodiment of a system according to the present invention. The system according to this embodiment has a personal computer 12 serving as a user terminal, a display 11 for overlaying and showing information of an application program realized by the present invention and information of an external application program, such as a word processor, a keyboard 13 and a mouse 14 connected to the personal computer 12. The personal computer 12 obtains programs for performing a variety of processes, to be described later, by loading from a computer memory product 16, such as a magnetic disk, having the programs recorded therein.

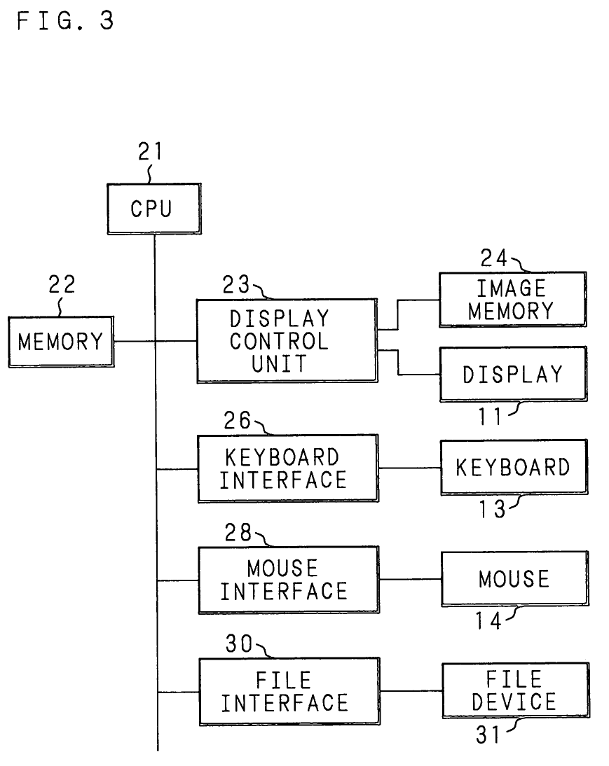

FIG. 3 is a block diagram showing the detailed structure of the system according to this embodiment. The system according to this embodiment has a CPU 21, a memory 22, a display control unit 23, an image memory 24, the display 11, a keyboard interface 26, the keyboard 13, a mouse interface 28, the mouse 14, a file interface 30 and a file device 31. The CPU 21, memory 22, display control unit 23, keyboard interface 26, the mouse interface 28 and the file interface 30 are connected to one another through a system bus.

The memory 22 stores application programs, operation configurations for the personal computer 12 and the like. The display control unit 23 controls reading/writing of image information to and from the image memory 24 and also controls the image memory 24 and the display 11 in such a manner that image information in the image memory 24 can be shown on the display 11. The display 11 comprises a CRT, a liquid crystal panel, a plasma display or the like. Information inputted from the keyboard 13 and pointed by the mouse 14 are, through the keyboard interface 26 and the mouse interface 28, supplied to the system bus. Note that the mouse interface 28 and the mouse 14 may be replaced with a tablet interface and an electronic pen. The file device 31 consists of a floppy disk, a hard disk or the like.

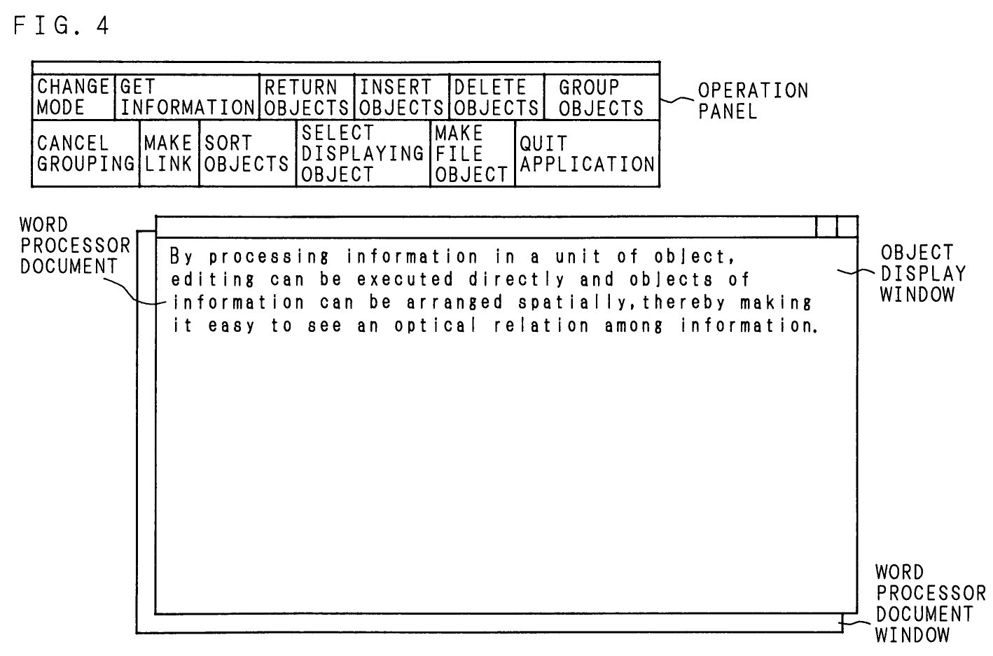

FIG. 4 shows an example of the appearance in an initial state according to the present invention. In this embodiment, a transparent window for showing information objects or the like processed by an application program (hereinafter called an “application in this system” realized by the present invention) is overlaid on a window for showing a document processed by a word processor. When the application in this system is turned on, an external application program (hereinafter called an “external application”), for example a word processor or the like, is turned on simultaneously, and a transparent window is created at the same position and in the same size as the window of the external application to be interposed thereon. Since the overlaid window for displaying the information object is transparent, information (the document processed by the word processor) shown in the external application (the word processor) can be seen through. If the window of the external application has been moved or the size of the window has been changed, the overlaid window can change its position or its size of the window into the same as those of the window of an external application program by obtaining the amount of movement.

Referring to FIG. 4, buttons of an operation panel will now be described. The operation panel has, from the left to the right as shown in FIG. 4, “change mode”, “get information”, “return objects”, “insert objects”, “delete objects”, “group objects”, “cancel grouping”, “make link”, “sort objects”, “select displaying object”, “make file object” and “quit application” buttons. The operation panel may have other various buttons.

The “change mode” button is a button for selecting an event to the application in this system (hereinafter called an “operation mode”) or an input to the word processor (hereinafter called an “input mode”), that is, to the external application. Whenever the “change mode” button is clicked, one mode is changed into another mode exclusively. The “get information” button is provided to obtain information selected in the word processor as an information object. The “return objects” button is operated to return the contents of the selected information object to the original external application which is the source of the information object, that is, to the word processor in this embodiment.

The “insert objects” button is operated to transfer the contents of the selected information object to an external application different from the original external application. The “delete objects” button is provided to delete the selected information object. The “group objects” button is prepared for grouping selected information objects and relating the information objects to one another. The “cancel grouping” button can be clicked only when the selected information objects have been grouped. By clicking the button, grouping among information objects is canceled. The “make link” button is operated when the selected information object is related to another information object. The “make link”, different from “grouping”, causes a hierarchical relationship to be generated between the information objects.

The “sort objects” button is operated to show the information objects in the order required by a user. The method of the arrangement may be selected by a user from options including an arrangement in order of date of creation, a priority or the like. The “select displaying object” button is operated to show only information objects which satisfy a predetermined condition. The condition includes, for example, to show only 10 latest information objects, to show only master information objects or the like. The “make file object” button is operated to treat a file stored in a magnetic disk or the like as an information object. The “quit application” button is operated to quit the application in this system.

Then, an object table of the information storing means 1 will now be described. The object table stores “index” and “object pointer”. The “index” indicates the serial number of the information object in the table. When the information object has been deleted, the indexes following the deleted information object are decreased. An “object pointer” is a pointer for the address on the memory storing a variety of information items of the information object. By referring to this pointer, the attribute and contents of the actual information object can be retrieved from the memory.

Information for each information object, such as “previous object pointer”, “next object pointer”, “master object pointer”, “slave object pointer”, “group index”, “information type”, “priority”, “time stamp”, “display coordinate”, “object region” and “contents”, is stored in the memory. Moreover, additional information may be stored.

A pointer for an information object just before its own information object at the same level (for example, a master object or a slave object of another object) is set as the “previous object pointer”. If its own information object is at the beginning, NULL is set. A pointer for another information object at the same level just after its own information object is set as the “next object pointer” if one exists. If no information object exists at the same level, the value is NULL. A pointer for a master information object referred to its own information object is set as the “master object pointer” if one exists. A point for a slave information object referred to its own information object is set as the “slave object pointer” if one exists. An index of a table storing information about a group is set as the “group index” when information objects are grouped. The value of the “group index” can be utilized when a reference to the group table is made. The group table stores the group indexes and pointers for all the grouped information objects.

The “information type” is used to determine the type of obtained information object and has attributes of text information, bitmap information, file information and the like. The “information type” makes it enable to recognize the meaning of the item “contents”, which is to be described later. The “priority” denotes the priority of an information object. Although the “priority” is set to NORMAL ordinarily, setting the priority to lower or higher makes it enable to show the information objects selectively. The “time stamp” means the date and time when the information object is created. The “display coordinates” stores relative coordinates from the upper-left corner of the window on which the information object is shown. When a new information object has been created, default value is set to the “display coordinates” and the previous coordinates are updated by an application executing means 6 when an event, such as movement, has been performed.

The “object region” stores a minimum rectangular region surrounding the information object. Specifically, the region is utilized for determining whether an information object is to be selected or not, or for surrounding an information object with rectangle to show the region. The rectangular region is calculated from a size of a text string or a bitmap in the screen and then it is stored automatically. In case that the information type is a text attribute, a pointer for a character string stored in the memory is set to the “contents”. In case that information type is a bitmap attribute, a pointer for a memory storing the bitmap is set to the “contents”. In case that information type is a file attribute, full path to the file is set to the “contents”.

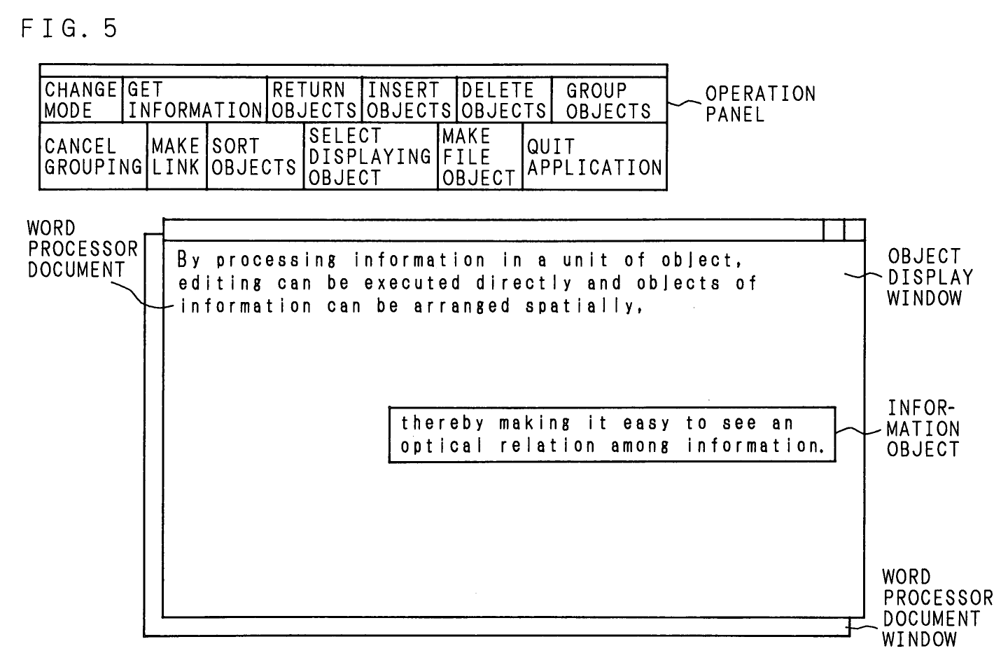

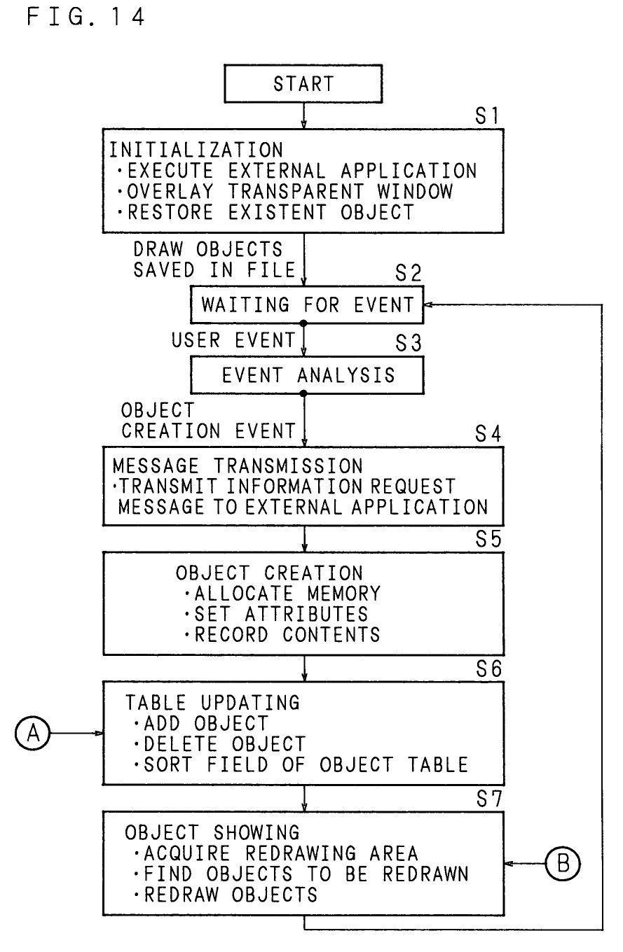

The operation of the system according to the present invention will now be described. FIGS. 5 to 13 are schematic views showing examples of windows when the system according to the present invention is being operated. FIGS. 14 to 18 show the sequence of the operations of the system according to the present invention.

In an initial state just after the application in this system has been executed, an input event is transferred to an external application. The foregoing arrangement is realized such that the transparent window of the application in this system receives all of input events or messages and checks the mode at the time of the receiving step. If the mode is set to an input mode for the external application, the input event or the message received by the application in this system is transmitted to the external application (S1). Then, the application in this system goes to a state for waiting an event from a user (S2).

The operation to be performed when a new information object is obtained or created from an external application (a first aspect) will now be described. In this case, a sequence of S2, S3, S4, S5, S6, S7 and S2 shown in FIG. 14 is performed.

When a text string inputted in the word processor is selected by the mouse 14 or the like in an event waiting state, and then “get information” button on the operation panel is clicked, the event analyzing means 3 analyzes the event and notifies a result of the analysis of the application executing means 6. The application executing means 6 responses to the notified information event to make the message transmitting means 4 issue a message to the word processor to copy the selected text string of the word processor on the memory. An object ID for identifying the word processor for which is required on transmitting the message has been obtained when the windows are overlaid at the time of initialization. The word processor responses to the received message and copies the selected information on the memory to a buffer so that the selected text string is cleared from its own window.

The application executing means 6 confirms that the information has been copied onto the memory and obtains the information. Then, the application executing means 6 creates a new information object on the memory and notifies the information storing means 1 of the pointer for the new information object. The information storing means 1 sets an appropriate “index” and notified object pointer to the object table. Moreover, the application executing means 6 stores, the previous object pointer”, the “information type”, “priority”, the “time stamp”, the “display coordinates”, the “object region” and the “contents”, in the memory address pointed by the “object pointer”. The “previous object pointer” is set to the last information object at the same level by looking into the information stored in the object table. Simultaneously, the item of “next object pointer” of the information object pointed by the “previous object pointer” is updated with the own pointer value. Default values are set to the “priority” and the “display coordinates” as temporary values. Time when the information object has been obtained is stored for the “time stamp”. A value of the region calculated from the length of the obtained text string is stored for the “object region” automatically.

After the application executing means 6 has stored the attribute and contents of the new information object into the memory, the application executing means 6 makes the drawing means 2 show the new information object. The drawing means 2 retrieves information for drawing from the object pointer stored in the object table and then obtains the contents and the display coordinates so as to show the information object on the window (see FIG. 5). At this time, the drawing means 2 may redraw existing information objects, if necessary, as well as the new information object.

An information object can be created with bitmap attribute by selecting a certain region by the mouse, which has a part of the screen as its contents.

When a user operates the mouse 14 or the like to click an information object in the operation mode, the event analyzing means 3 obtains the clicked locations and checks whether or not the coordinates are within an object region of the existing information object by the following method. Whether or not the coordinates of all the information objects are within the object region is, by using an object pointer, checked in the ascending order of the indexes in the object table. If it is confirmed that the click occurred within any of the information object regions, the information object goes to a selected state. The selected information object is indicated to a user in such a way that the object region is surrounded by, for example, a thick line rectangle.

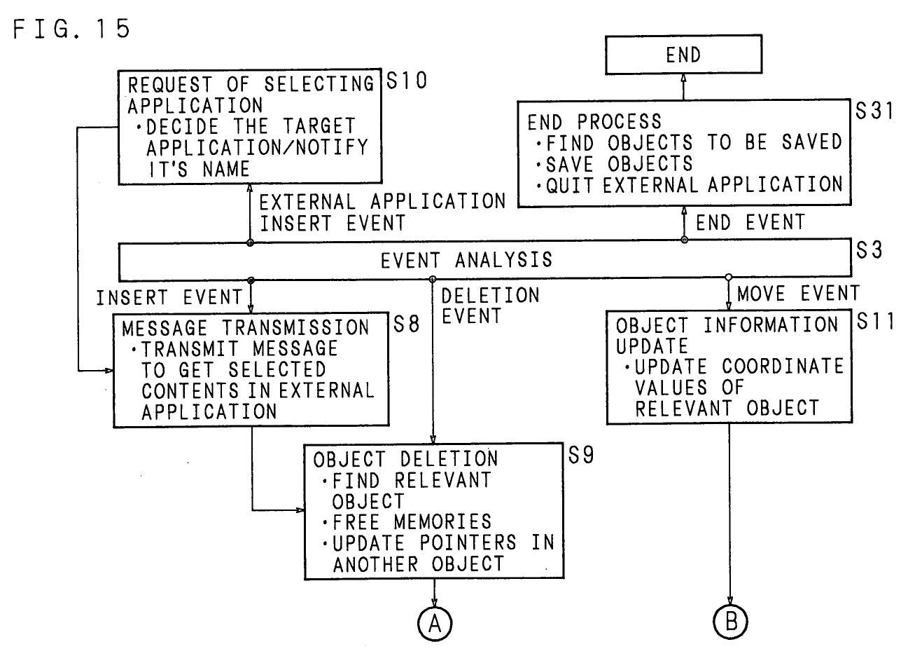

The operation to be performed in case that an information object is returned to the original external application (a second aspect) will now be described. In this case, a sequence of S2, S3, S8, S9, S6, S7 and S2 shown in FIGS. 14 and 15 is performed.

If a user clicks the “return objects” button when an information object has been selected, the event analyzing means 3 analyzes the event to notify the index of the object table of the selected information object and the issued “return objects” command to the application executing means 6. The application executing means 6 retrieves a pointer for the selected object from the object table, and obtains the contents of the information object to copy the data onto a buffer memory. Moreover, the application executing means 6 transmits a message to the word processor in order for the word processor to obtain data from the buffer memory. The word processor gets data in response to the message and shows the obtained data on the window.

The application executing means 6 transmits the message as described above, and then clears all the information of the object in the object table in the information storing means 1, and sorts the contents in the object table appropriately. Moreover, the application executing means 6 replaces the value of the “next object pointer” of the object just before returned object with the value of the “next object pointer” of the returned object to free the memory allocated for the returned information object. Then, the application executing means 6 makes the drawing means 2 clear, from the own window, the region where the returned information object has existed. The drawing means 2 redraws the region in response to the notification.

The operation to be performed in case that an information object is transferred to another external application different from the original external application (a third aspect) will now be described. In this case, a sequence of S2, S3, S10, S8, S9, S6, S7 and S2 shown in FIGS. 14 and 15 is performed.

When a user clicks the “insert objects” button in a state where an information object has been selected, the event analyzing means 3 analyzes an input event and enters a state waiting for deciding where the contents is inserted. When the user clicks the application which the contents is inserted for, with the mouse 14 for example, the event analyzing means 3 gets the ID for identifying the application and notifies the application executing means 6 of the index of the selected information object, the issued “insert objects” command and the ID for identifying the application.

The application executing means 6 retrieves a pointer for the selected object from the object table in accordance with the notified index. Moreover, the application executing means 6 obtains the contents of the information object in accordance with the pointer to copy the data onto the temporary buffer memory. The application executing means 6 makes the message transmitting means 4 transmit a message to which the ID identifying the application notified by the event analyzing means 3 in order for the external application to obtain data on the buffer memory. The external application specified by the user obtains the data in response to the above-mentioned message and show the contents on the window.

The application executing means 6 transmits the message as described above, and then clears all the information of the object in the object table, and sorts the contents in the object table appropriately. The application executing means 6 replaces the value of the “next object pointer” of an object just before the inserted object with the value of the “next object pointer” of the inserted object to free the memory allocated by the inserted information. Moreover, the application executing means 6 notifies the drawing means 2 of clearing, from its own window, the region where the relevant object has existed. The drawing means 2 redraws the region in response to the notification.

The operation to be performed in case that an information object is moved to any position on the window (a fourth aspect) will now be described. In this case, a sequence of S2, S3, S11, S7 and S2 shown in FIGS. 14 and 15 is performed.

If a user drags an information object with the mouse when the information object has been selected, the event analyzing means 3 analyze an event and notifies the application executing means 6 of the index of the object table, the “move objects” command and the amount of movement. The application executing means 6 retrieves a pointer for the selected object from the object table in accordance with the notified index. Moreover, the application executing means 6 updates the value of the location in the object table by recalculating the location with the notified amount of movement. The application executing means 6 makes the drawing means 2 redraw a required region on the window. The drawing means 2 redraws the region in response to the notification.

An information object can be also moved to any place by clicking the destination with the mouse after selecting the information object and then clicking the “move object” button.

The operation to be performed in case that a created information object is to be deleted (a fifth aspect) will now be described. In this case, a sequence of S2, S3, S9, S6, S7 and S2 shown in FIGS. 14 and 15 is performed.

If a user clicks the “delete objects” button on the operation panel when the information object has been selected, the event analyzing means 3 analyzes an event and notifies the application executing means 6 of the index of the object table and the “delete object” command. The application executing means 6 clears the object table of the selected information object in the information storing means 1 and sorts the contents in the object table appropriately. Moreover, the application executing means 6 replaces the value of the “next object pointer” of the object just before the deleted object with the value of the “next object pointer” of the deleted object so as to free the memory allocated for the deleted information object. Then the application executing means 6 makes the drawing means 2 clear, from the window, the region where the relevant information object has existed. The drawing means 2 draws the region again, in response to the notification.

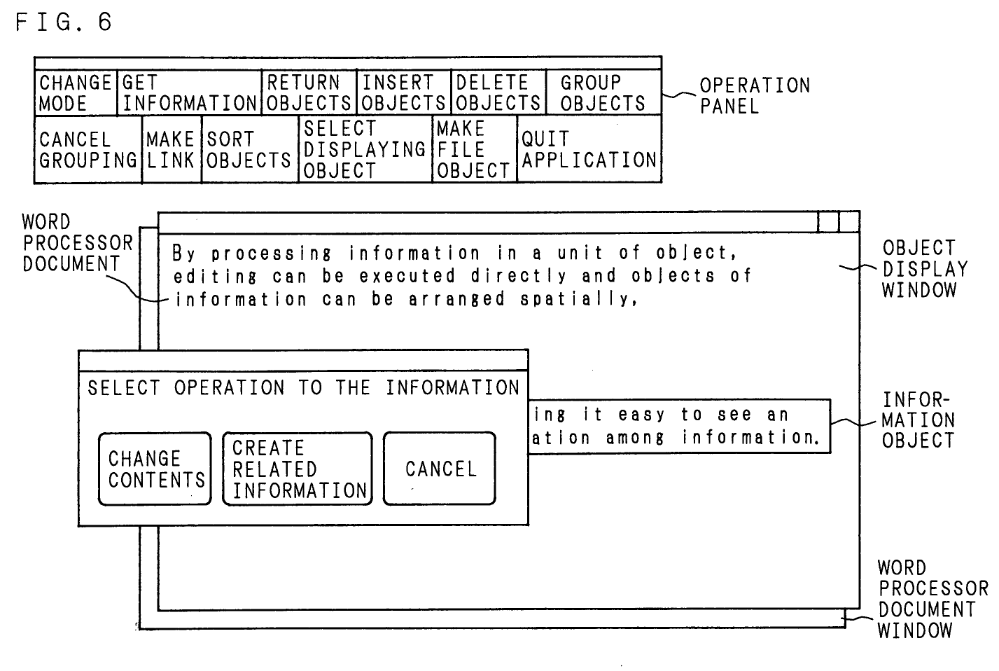

When the information object is double-clicked by a user, the event analyzing means 3 analyzes the event to notify the contents displaying means 5 of the index of the object table. The contents displaying means 5 asks the user whether he/she changes the contents of the information object or creates a new related information object to it, and then is in a state waiting for an event (see FIG. 6).

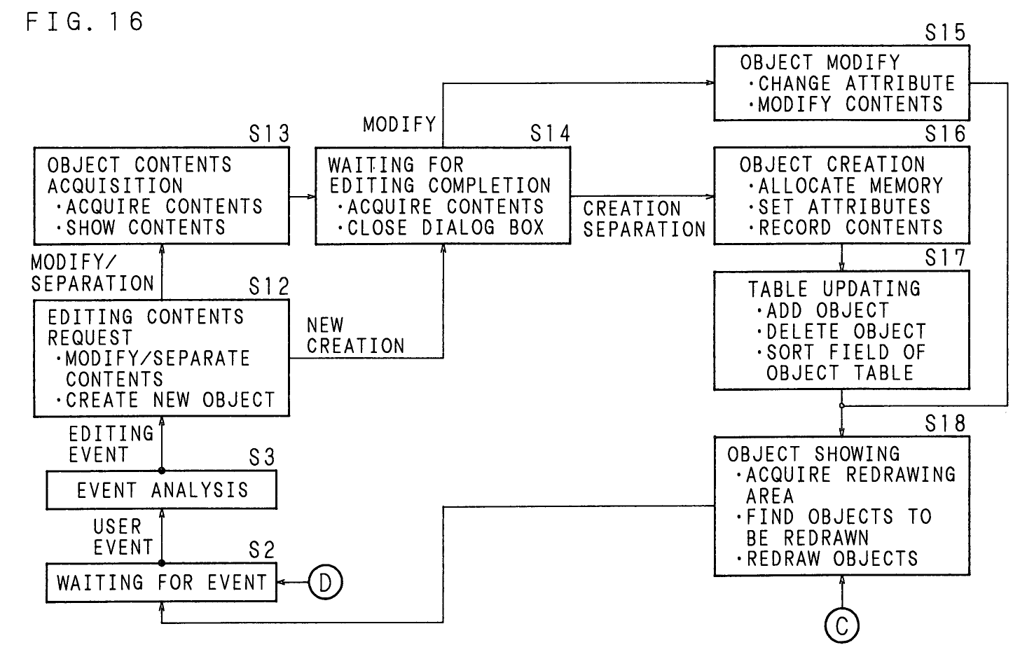

The operation to be performed in case that the contents of the information object are changed (a sixth aspect) will now be described. In this case, a sequence of S2, S3, S12, S14, S15, S18 and S2 shown in FIG. 16 is performed.

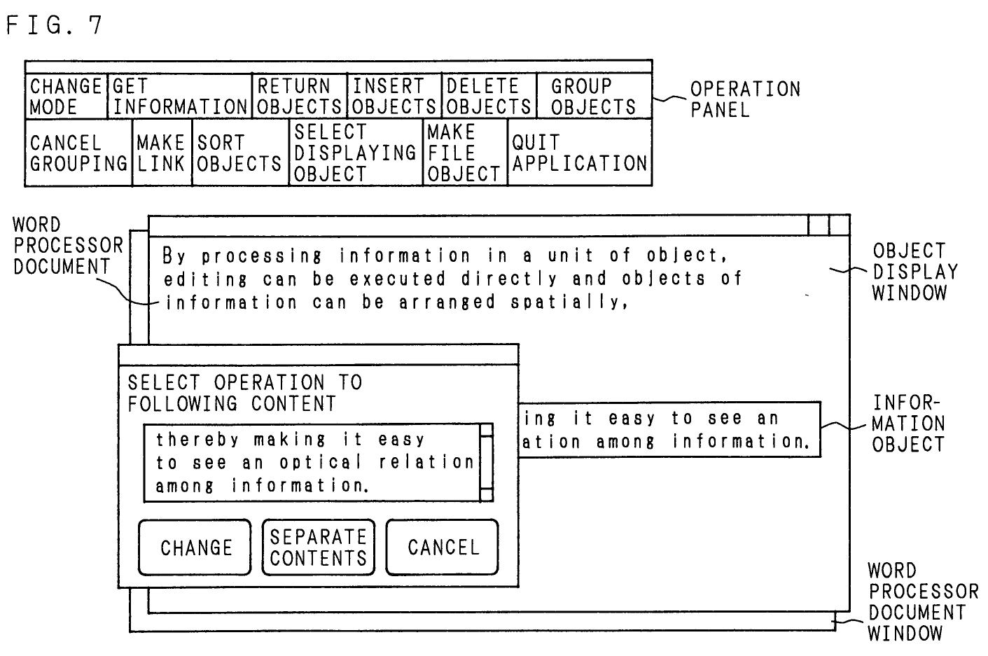

In FIG. 6, when the user clicks the “change contents” button, the contents display means 5 retrieves the pointer for the selected information object from the object table in accordance with the notified index and obtains the contents in accordance with the pointer. Moreover, the contents displaying means 5 shows the contents in the dialogue box, and then goes to a state waiting for an event (see FIG. 7). Since the “change” button is invalid until the contents are actually changed, it cannot be pushed.

When the user changes the contents and clicks the “change” button, the contents displaying means 5 obtains the changed contents, closes the dialogue box and notifies the application executing means 6 of the index of the object table and the changed contents of the information object. If the “cancel” button is clicked, the dialogue box is closed and the following process is not performed.

The application executing means 6 retrieves a pointer for the double-clicked object from the object table in accordance with the notified index. Moreover, the application executing means 6 changes the previous contents of the information object into the changed contents. Simultaneously, the application executing means 6 replaces the old date and time to the time when the contents has been changed, and recalculates the object region and updates the item of the object automatically. The application executing means 6 makes the drawing means 2 redraw the information object, the contents of which have been changed. The drawing means 2 redraws the region in response to the notification.

The contents of the information object can be also shown in the dialogue box for changing the contents by selecting an information object and then clicking the “change contents” button.

The operation to be performed in case that information related to an information object is created (a seventh aspect) will now be described. In this case, a sequence of S2, S3, S12, S14, S16, S17, S18 and S2 shown in FIG. 16 is performed.

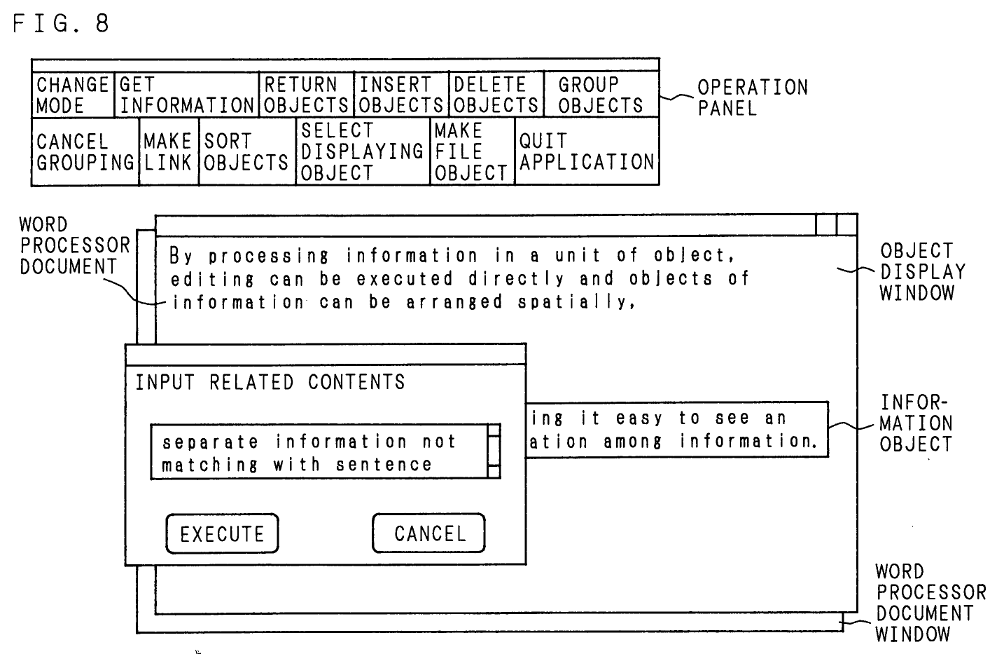

In FIG. 6, when the “create related information” button is clicked, the contents displaying means 5 displays a dialogue box for creating related information is displayed (see FIG. 8). In FIG. 6, since the “create related information” button is made invalid until the contents are actually inputted, it cannot be pushed. When a user has inputted the contents and clicks the “create related information” button, the contents displaying means 5 obtains the created contents, and then closes the dialogue box. Then, the contents displaying means 5 notifies the application executing means 6 of the index of the object table and the inputted contents of the information object. When the “cancel” button is clicked, the dialogue box is closed and the following process is not performed.

The application executing means 6 creates an information object that has the notified contents as a new information object, and then sets a pointer for the new information object to the object table. The application executing means 6 sets the value of the pointer for the notified information object to the item “master object pointer” of the new information object, and then sets the value of the pointer for the new information object to the item “slave object pointer” of the notified information object. Moreover, the location of the new information object are calculated in order to be located near the master information object and set the calculated value to the item “display coordinates” of the new object. Furthermore, the application executing means 6 makes the drawing means 2 redraw a required region on the window. The drawing means 2 redraws the region in response to the notification.

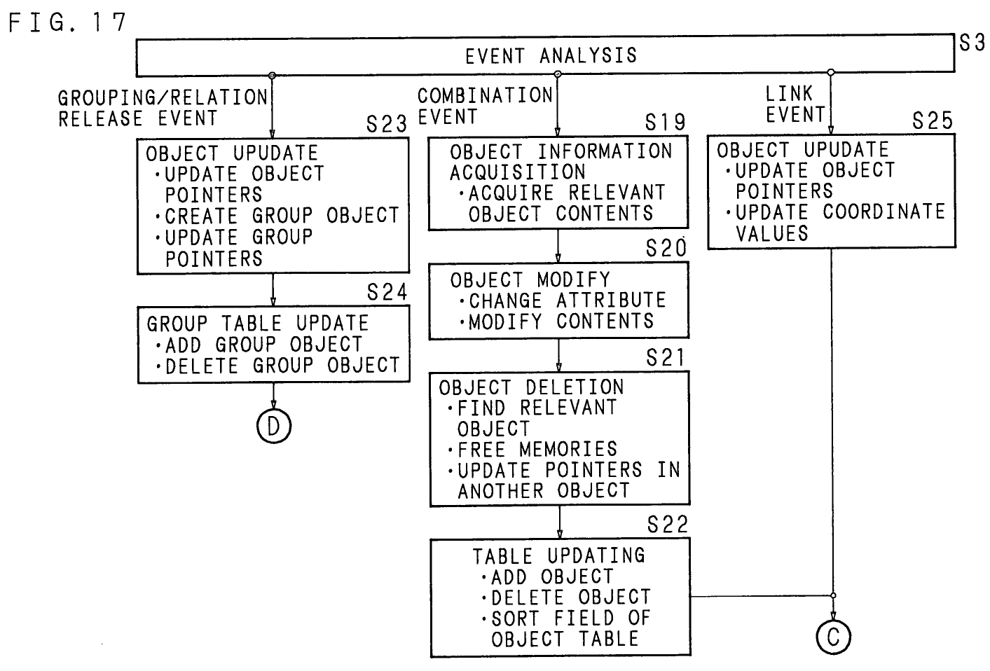

The operation to be performed in case that two information objects are combined (an eighth aspect) will now be described. In this case, a sequence of S2, S3, S19, S20, S21, S22, S18 and S2 shown in FIGS. 16 and 17 is performed.

When a user drags an information object when the information object has been selected and then placed onto another information object, the event analyzing means 3 analyzes an event and notifies the application executing means 6 of the index of the object table for the placing information object, the index of the object table for the placed information object and “combine objects” command.

The application executing means 6 retrieves pointers of the two information objects from the object table by the notified indexes, obtains the contents in accordance with the pointers above and appends the contents of the placing information object to the end of the placed information object so as to change the contents of the placed information object. Moreover, the application executing means 6 clears the object table of the placing object to sort the contents in the object table appropriately. In addition, the application executing means 6 replaces the value of the item “next object pointer” of the information object just before the placing information object with the value of the item “next object pointer” of the placing information object so as to free the memory allocated by the placing information. Then, the date and time when information of the placed information object has been changed and the object region are updated automatically. Then, the application executing means 6 makes the drawing means 2 clear, from the window, the region where the placing information object has existed. In response to the notification, the drawing means 2 redraws the region.

The operation to be performed in case that one information object is separated into two information objects (a ninth aspect) will now be described. In this case, a sequence of S2, S3, S12, S13, S14, S16, S17, S18 and S2 shown in FIG. 16 is performed.

In FIG. 7, when a part of the contents of an information object is selected and a user pushes the “separate object” button, the event analyzing means 3 notifies the application executing means 6 of the index of the object table of the first half of the contents (the first contents), the “separate object” command and contents of the second half of the contents (the second contents). The application executing means 6 retrieves the pointer for the selected information object from the object table in accordance with the notified index and replace the contents with the notified second contents. Moreover, it updates the date and time and recalculates the object region automatically. Moreover, a new information object is created and its pointer is stored in the object table. The notified first contents and the like are set to the items of the new object. Then, the application executing means 6 makes the drawing means 2 redraw a required region on the window. The drawing means 2 redraws the information objects in the region in response to the notification.

The operation to be performed in case that information objects are grouped into one group (a tenth aspect) will now be described. In this case, a sequence of S2, S3, S23, S24 and S2 shown in FIGS. 16 and 17 is performed.

When a user clicks the “grouping” button on the operation panel in case that information objects have been selected, the event analyzing means 3 analyzes an event to notify the application executing means 6 of all the indexes of the object table and a “group objects” command. The application executing means 6 retrieves the object pointers from the object table in accordance with the notified indexes to create a new group object on the memory, and then sets the pointer for the new group object on the group table. All the pointers for the notified information objects are set to the group object and a minimum region including all the information objects is calculated as a group region and set to the group object. Moreover, the index of the group table is set to the item “group index” of each information object.

Information objects can be also grouped into one group object by clicking the “group objects” button and then surrounding some information objects to be grouped by a mouse and the like.

The operation to be performed in case that a grouped information object is moved on the window (an eleventh aspect) will now be described. In this case, a sequence of S2, S3, S11, S7 and S2 shown in FIGS. 14 and 15 is performed.

When a user drags an information object group in a selected state, the event analyzing means 3 analyzes an event to notify the application executing means 6 of the index of the group table, the “move objects” command and the amount of movement. The application executing means 6 retrieves all the pointers for the grouped information object from the group table in accordance with the notified index of the group table. As a result, the display coordinates of all the grouped information objects are updated by the notified amount of movement. Moreover, the application executing means 6 makes the drawing means 2 redraw a required region of the window. In response to the notification, the drawing means 2 redraws the region.

The operation to be performed in case that an information object group is deleted (a twelfth aspect) will now be described. In this case, a sequence of S2, S3, S9, S6, S7 and S2 shown in FIGS. 14 and 15 is performed.

When a user clicks the “delete objects” button on the operation panel in a state where grouped information objects have been selected, the event analyzing means 3 analyzes an event and notifies the application executing means 6 of the index of the group table and the “delete objects” command. The application executing means 6 retrieves all pointers for the grouped information object from the group table in accordance with the notified index of the group table.

The application executing means 6 clears the object table of all the information objects that are grouped, and then sorts the contents in the object table appropriately. Moreover, the application executing means 6 replaces the value of the item “next object pointer” of the object just before the deleted object with the value of the item “next object pointer” of the deleted object to free the memory allocated by the deleted information object. This process is repeated for all the information objects retrieved from the group table in accordance with the notified index. Moreover, the application executing means 6 clears the group object from the group table to free the memory and sorts the contents in the group table appropriately. Then, the application executing means 6 makes the drawing means 2 clear, from the window, the region, where the relevant information object has existed, by using the minimum rectangular region obtained from the group table. In response to the notification, the drawing means 2 redraws the region.

The operation to be performed in case that a grouping relationship among information objects is canceled (a thirteenth aspect) will now be described. In this case, a sequence of S2, S3, S23, S24 and S2 shown in FIGS. 16 and 17 is performed.

When a user clicks the “cancel grouping” button on the operation panel in a state where the grouped information objects have been selected, the event analyzing means 3 analyzes an event, and then notifies the application executing means 6 of the index of the group table and a “cancel grouping” command. The application executing means 6 retrieves all the pointers for the grouped information object from the group table in accordance with the notified index of the group table, and clears the item “group index” of all the information objects. Moreover, the group object is cleared from the group table to free the memory and sorts the contents in the group table appropriately.

The operation to be performed in case that the relationship between the master and slave is set to link two information objects with hierarchical relationship (a fourteenth aspect) will now be described. In this case, a sequence of S2, S3, S25, S18 and S2 shown in FIGS. 16 and 17 is performed.

When a user clicks the “make link” button on the operation panel in a state where an information object has been selected, the event analyzing means 3 analyzes an event and waits for a notification of the linking object from the user. When the user then selects another information object, the event analyzing means 3 notifies the application executing means 6 of the index of the object table of the just selected information object (linking information object: slave information object), the index of the object table of the information object (a linked information object: master information object) which is selected before clicking the button and the “make link” command.

The application executing means 6 retrieves the pointer of the master information object in accordance with the index of the object table. When it doesn't have a slave information object, the pointer for the slave information object is set to the item “slave object pointer” of the master information object. If it has the slave information object, the pointer of the slave information object is set to the item “next object pointer” of the last slave information object. Moreover, the value of the item “next object pointer” of the slave information object is set to the item “next object pointer” of the information object indicated with the item “previous object pointer” of the slave information object and sets its own item “next object pointer” to NULL. In addition, the pointer for the master information object is set to the item “master object pointer” of the slave information object, and then the “display coordinates” are calculated in such a manner that the information object is located near the master information object, and are updated.

Then, the application executing means 6 makes the drawing means 2 redraw a required region of the window. In response to the notification, the drawing means 2 redraws the region.

If an arrow is shown from the master information object to the slave information object to clarify the link, the relationship between the objects can be easily recognized.

The operation to be performed in case that linked information object is deleted (a fifteenth aspect) will now be described. In this case, a sequence of S2, S3, S9, S6, S7 and S2 as shown in FIGS. 14 and 15 is performed.

When a user clicks the “delete objects” button on the operation panel in a state where an information object has been selected, the event analyzing means 3 analyzes an event to notify the application executing means 6 of the index of the object table and the “delete objects” command. The application executing means 6 retrieves the pointer for the selected information object in accordance with the notified index of the object table.

When the selected information object has linked information object and is the only slave information object, the item “slave object pointer” of the information object indicated by the “master object pointer” is cleared, then clears the object table of the selected information object, sorts the contents in the object table appropriately and frees the memory allocated for the information object. If the selected information object is not the only slave information object, the value of the item “next object pointer” of the information object is set to the value of the item “next object pointer” of the information object indicated by the item “previous object pointer” of the information object. If the “previous object pointer” is NULL, the pointer for the information object indicated by the item “next object pointer” of the information object is set to the item “slave object pointer” of its master object, clears the object table of the information object, sorts the table appropriately and frees the memory allocated for the information object.

When the selected information object is the master information object, the value of the item “slave object pointer” of the information object is set to the item “next object pointer” of the information object indicated by the item “previous object pointer” of the information object. Moreover, the value of the item “next object pointer” of the information object is set to the item “next object pointer” of the last slave information object of the information object and the value of the item “master object pointer” of the information object is set to the item “master object pointer” of all the slave information objects. The object table of the information object is cleared, and then the contents in the object table is sorted appropriately followed by freeing the memory allocated for the information object.

Then, the application executing means 6 makes the drawing means 2 redraw a required region of the window. In response to the notification, the drawing means 2 redraws the relevant region.

The operation to be performed in case that the information object which has linked information object is shown in a different way from the information object which has no linked information object (a sixteenth aspect) will now be described.

When the drawing means 2 shows an information object and the information object has a linked information object, it is shown in such way that it can be easily recognized as an object which has linked information object. What it has linked information object may be indicated by another method, such as a method in which the background color of the rectangle around the contents is changed or a method in which a mark is added to the inside of the rectangle.

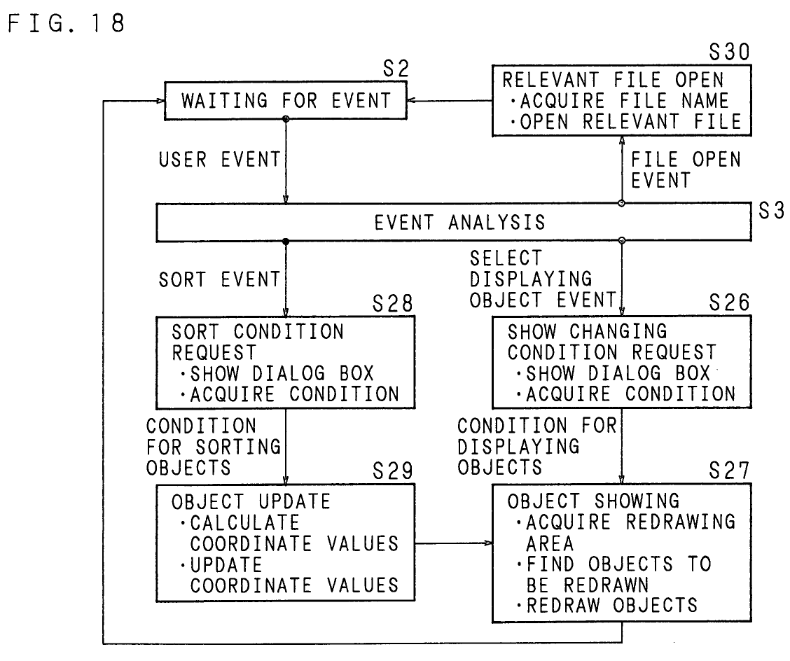

The operation to be performed when only an information object satisfying a certain condition is shown on the window will now be described. In this case, a sequence of S2, S3, S26, S27 and S2 shown in FIG. 18 is performed.

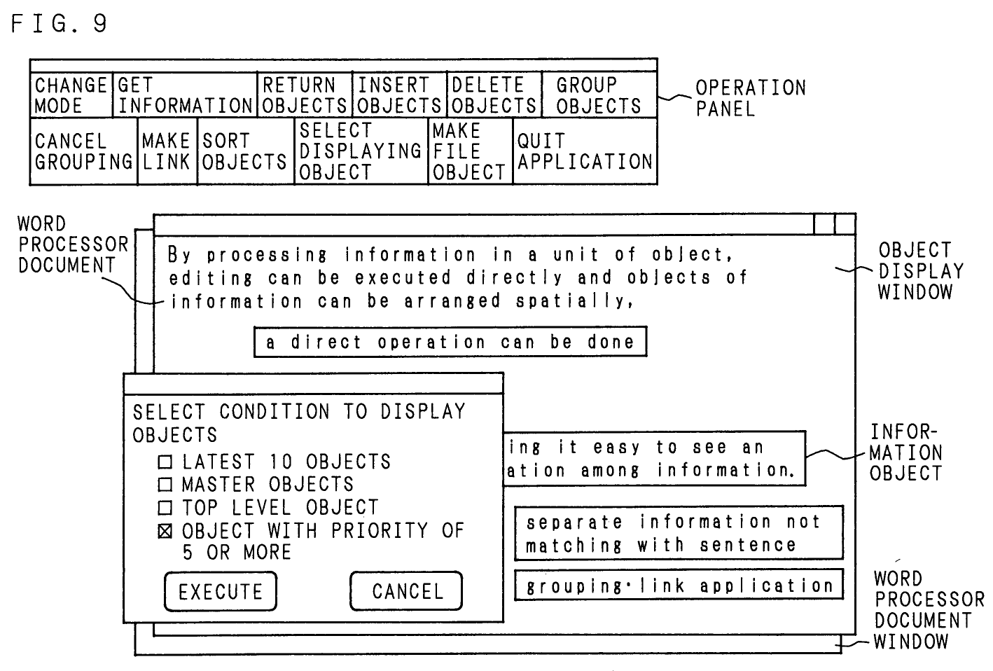

When a user clicks the “select displaying object” button, the event analyzing means 3 analyzes an event and notifies the application executing means 6 of a “select displaying object” command. The application executing means 6 shows a dialogue box for selecting a condition for the displaying object (see FIG. 9) to accept input from the user. The “execute” button is invalid and cannot be pushed until the condition is actually selected.

When the condition has been selected by the user and the “execute” button is clicked, the application executing means 6 notifies the drawing means 2 of the condition and closes the dialogue box. Then, the application executing means 6 makes the drawing means 2 redraw all the information objects. In accordance with the notified condition, the drawing means 2 inspects the information object necessary to be drawn and displays, on the window, only the information object which should be drawn, selectively. When the “cancel” button is clicked, the drawing means 2 only closes the dialogue box but does not perform the redrawing operation.

The operation to be performed in case that the displaying order is set and information objects are arranged in the order will now be described. In this case, a sequence of S2, S3, S28, S29, S27 and S2 shown in FIG. 18 is performed.

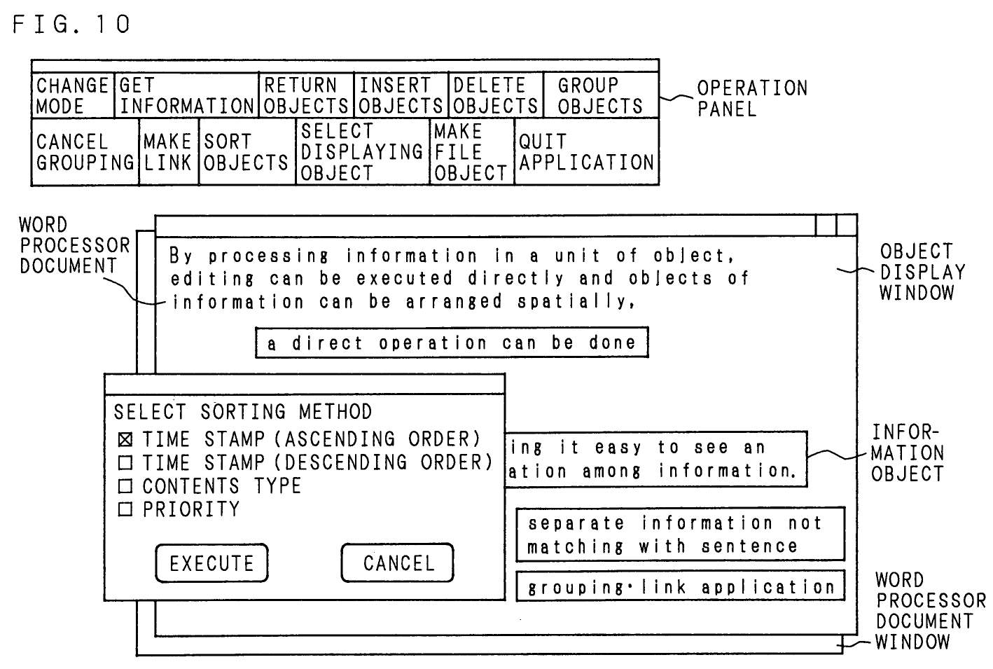

When a user clicks the “sort objects” button, the event analyzing means 3 analyzes an event and notifies the application executing means 6 of a “sort objects” command. The application executing means 6 shows a dialogue box for selecting the sorting condition (see FIG. 10) and accepts input from the user. Each condition is exclusively controlled and thus only one condition can be selected. The “execute” button is invalid and cannot be pushed until the condition is actually selected.

When the user has selected the condition and the “execution” button is clicked, the application executing means 6 notifies the drawing means 2 of the condition, and then closes the dialogue box. Then, application executing means 6 makes the drawing means 2 redraw all information objects. The drawing means 2 updates the display coordinates of the information object in accordance with the notified condition automatically. When the time stamp (in the ascending order) has been selected as a condition, the information objects are arranged in the order of the date and time of creation starting with the latest one so as to be displayed. When the “cancel” button is clicked, the dialogue box is only closed and the redrawing process is not performed.

The operation to be performed in case that a file stored in a storage medium is selected, obtained as an information object and opened will now be described. In this case, a sequence of S2, S3, S30 and S2 shown in FIG. 18 is performed.

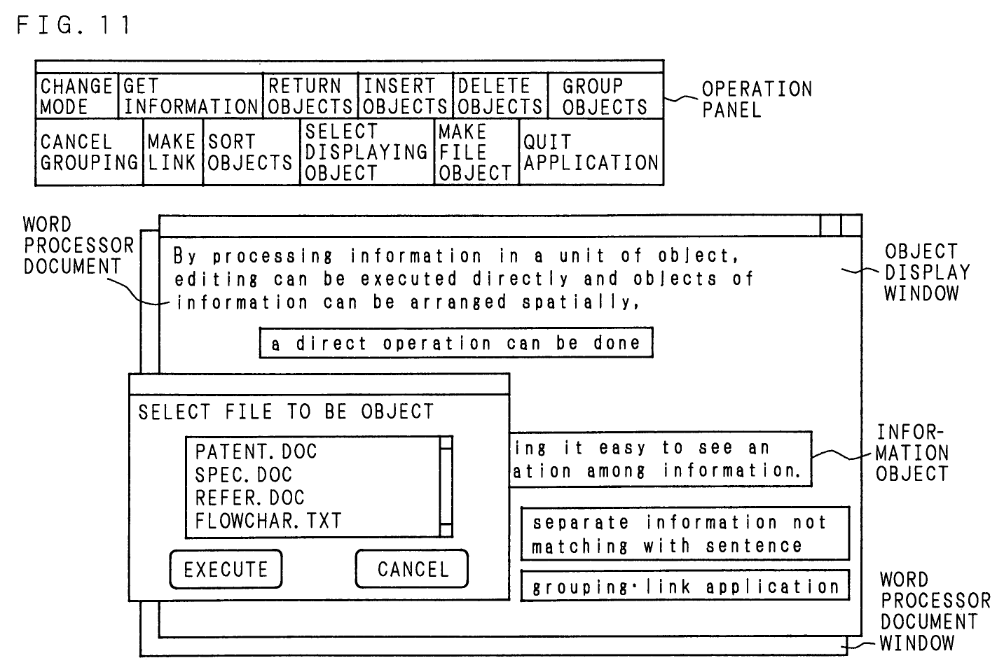

When a user clicks the “create file object” button, the event analyzing means 3 analyzes an event and shows a dialogue box showing a list of files stored in a magnetic disk (see FIG. 11) to accept file to be selected from the user. Since the “execute” button is invalid until file name is inputted, it cannot be pushed. When the user selects a file and clicks the “execute button, the event analyzing means 3 notifies the application executing means 6 of a “make file object” command and the full path of the selected file.

The application executing means 6 creates a new information object on the memory and notifies the information storing means 1 of the pointer for the new object. The information storing means 1 sets an appropriate “index” and the notified “object pointer” to the object table. Moreover, the application executing means 6 stores, into the memory address pointed by the “object pointer”, the “previous object pointer”, the “information type”, the “priority”, the “time stamp”, the “display coordinates”, the “object region” and the “contents”. The “file attribute” is stored in the “information type”, while the full path of the file is stored in the “contents”. A pointer for the last information object at the same level is set to the item “previous pointer” of the created file information object. Simultaneously, the value of the item “next object pointer” of the information object indicated by the “previous object pointer” of the created information object is updated by the value of the pointer of the created information object. Default values are stored as temporary values as for the “priority”, the “display coordinates” and the “object region”. The time when the file information object has been created is stored as the “time stamp”.

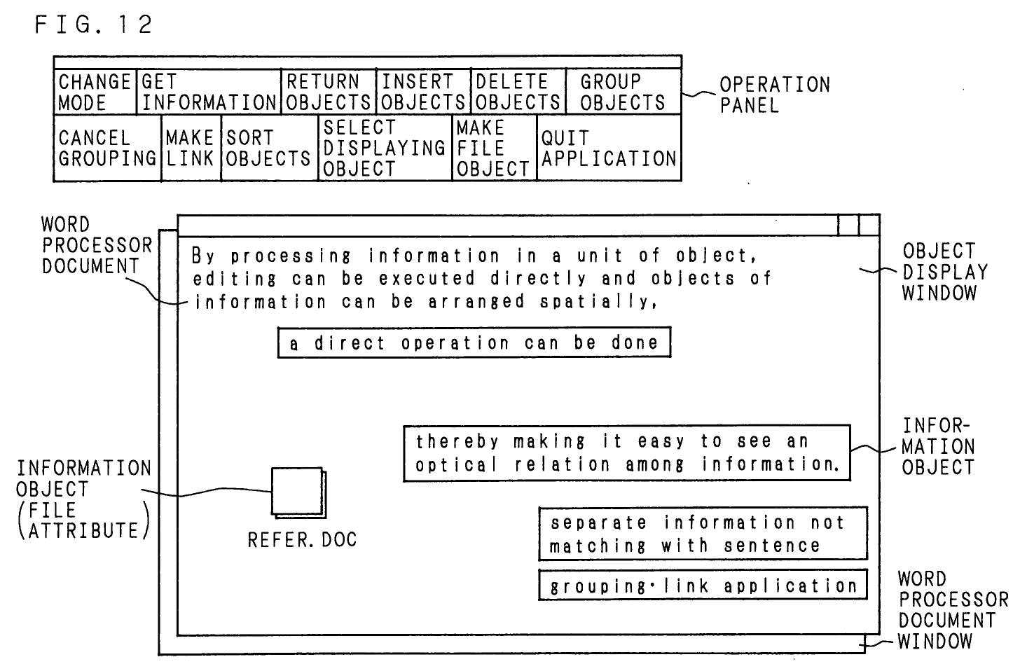

As described above, the attribute and the contents of the new file information object are stored in the memory, and then the application executing means 6 makes the drawing means 2 display the new information object. The drawing means 2 shows a file information object with an icon to which file name is added under the icon (see FIG. 12). The file information object can be also created by the drag-and-drop of the file onto the window of this application.

When a user double-clicks an information object, the event analyzing means 3 analyzes an event and inspects the information type of the double-clicked information object. If the information object has the file attribute, a “file open” command and full path of the file are notified to the application executing means 6. The application executing means 6 opens the notified file.

The operation to be performed in case that an information object is to be stored in a file will now be described. In this case, a sequence of S2, S3 and S31 shown in FIG. 15 is performed.

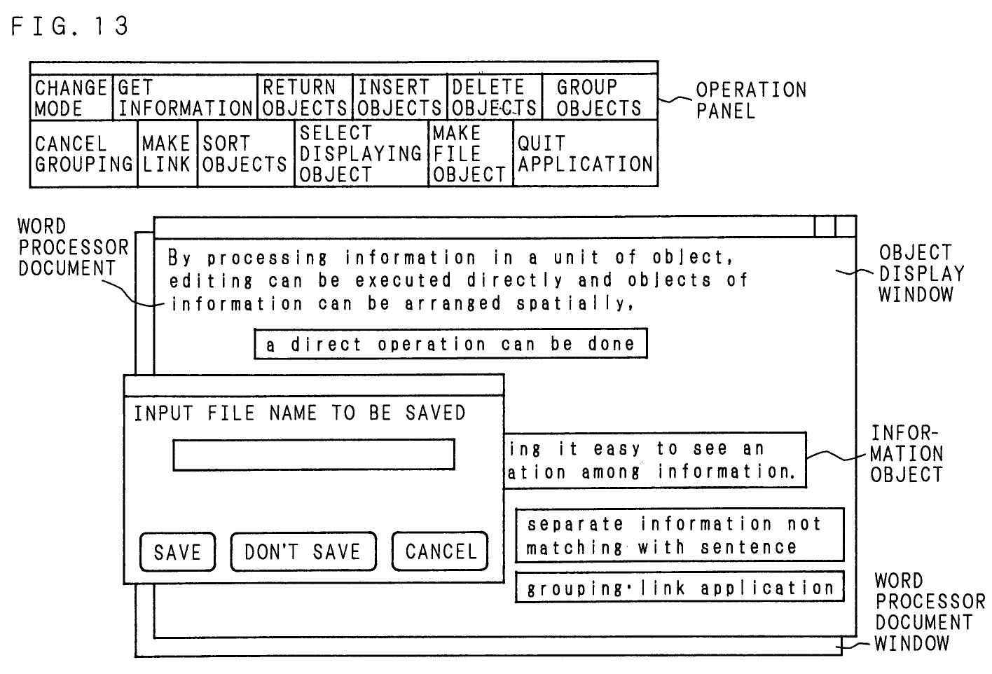

When a user clicks the “quit application” button, the event analyzing means 3 analyzes an event and issues a “quit application” command to the application executing means 6. The application executing means 6 goes to a state waiting for input of file the name from the user (see FIG. 13). The “save” button is invalid and cannot be pushed until file name is actually inputted.

When the user inputs a file name and clicks “save” button, the application executing means 6 obtains the file name that user inputs. If the inputted file name is the same as that of the existing file, this fact is notified to the user and asks the user whether he/she overwrites the file on the existing file or changes the file name to be saved. If the “don't save” button is clicked, no information is saved in the file. If the “cancel” button is clicked, the dialogue box is closed and the all of the following procedures are ignored.

The application executing means 6 creates a new file with the obtained file name, and information stored in the memory is written on the created file by using the pointer for the information object stored in the object table. This process is performed for all the information objects, and then the memory allocated for all the information objects is freed. Then, the overlaid word processor is shut down and also the application executing means 6 is quitted.

A case will now be considered in which a user has started the application in this system in such a manner that the file storing the information object is opened. This case is applied to a situation in which the file name is passed as a parameter for the start-up of the application.

When the file name is passed as the parameter when the system starts to run, the application executing means 6 reads the file and restores all information objects stored in the file onto the memory, followed by constructing an object table. After all the information objects have been restored onto the memory, the application executing means 6 makes the drawing means 2 show all the information objects. The drawing means 2 shows all the information objects stored in the object table.

Although the system according to the present invention is realized with a personal computer unit in the examples of the structures shown in FIGS. 2 and 3, the present invention can be realized in a communication network, such as LAN, in which personal computer units are connected to one another through a communication line.

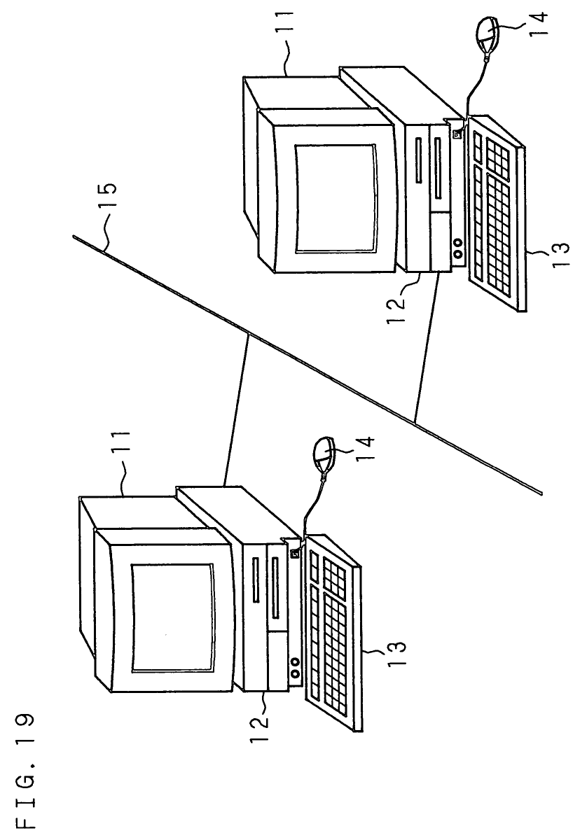

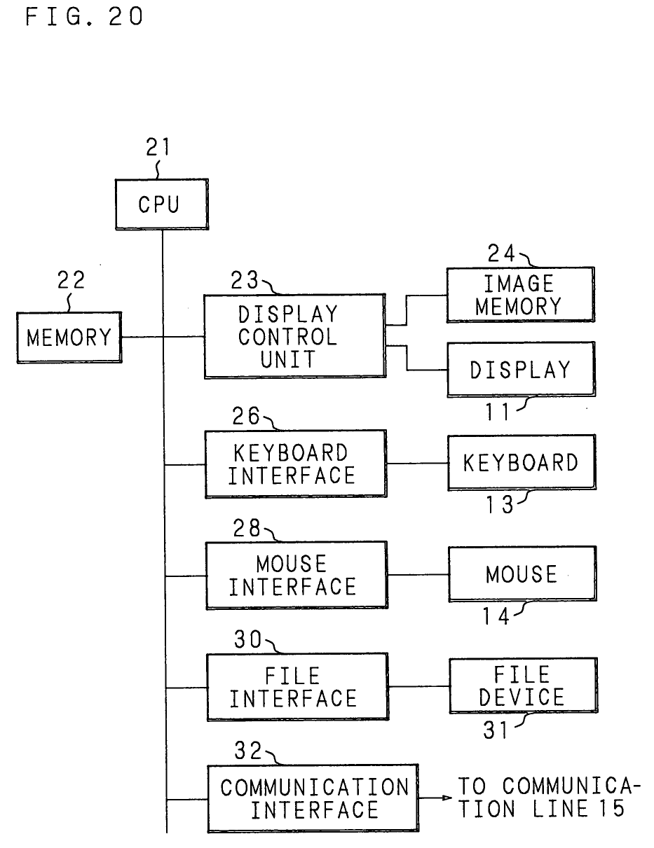

FIGS. 19 and 20 are a schematic view and a block diagram showing the basic structure of this type of a system. In FIGS. 19 and 20, the same elements as those shown in FIGS. 2 and 3 are given the same reference numerals and a description thereof is omitted. The two personal computer units communicate data through a communication interface 32 and a communication line 15. In this example of the structure, an information object displayed on a transparent window of either of the displays can be transferred from the other personal computer unit through the communication line 15. Moreover, the process, such as “returning”, “inserting”, “grouping”, “linking” and “sorting”, for the information object displayed on the transparent window of either of the displays can be controlled from the other personal computer through the communication line 15.

The information fragments editing system according to the present invention is able to treat a variety of information obtained from an external application as a unified information objects in one layer. Since an information fragment can be treated as an object, operations, such as moving, deleting and combining can be performed directly. Moreover, related information items can be arranged spatially and visually so that it is easy to know information fragments are related with one another. Therefore, this system can provide convenience for a user. Furthermore, it is very effective that the system has an ability to return the edited information to any external application finally.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims or equivalence of such metes and bounds thereof are therefore intended to be embraced by the claims.

1. An information fragments editing system for executing an application program for obtaining information from an external application program to show the obtained information as an information object, comprising:
a unit for displaying, on a window displaying information controlled by an external application program, a transparent window through which contents of the information controlled by the external application program is seen, said transparent window having a position and size being a same position and a same size as said window;
an information storing unit storing contents and attribute information of an information object to be shown, the attribute information being concerned with showing the information object and including object ID, object type, information type, priority for showing, time stamp, object ID of link-destination object and object ID of a next object which are able to be modified after being created as an information object;
a drawing unit drawing the information object on said transparent window in accordance with the contents and attribute information relating to the display of the object stored in said information storing unit, the drawing unit changing a manner of drawing the information object on the basis of the attribute information;
an event analyzing unit analyzing all the events from and to an operation system and reporting a result of the analysis;
a message transmitting unit transmitting a control message to an external application program in order to get a selected information in the external application program; and
a performing unit performing at least any one of processes including a process of controlling said information storing unit, a process of controlling said message transmitting unit and a process of controlling said drawing unit, in accordance with the result of the analysis reported from said event analyzing unit,
wherein in case that any information in an external application program has been selected and an event for obtaining the selected information has been analyzed by said event analyzing unit, the selected information is created as an information object so as to be shown on said transparent window by said drawing unit such that the information object appears different from any non-selected information in the external application program,
wherein when the position or the size of said window changes, said transparent window will automatically be changed to have the same position and size as that of said window.

2. An information fragments editing system according to claim 1, further comprising:
means for selecting a created information object; and
means for returning the contents of the selected information object to the original external application program from which the information object has been obtained.

3. An information fragments editing system according to claim 1, further comprising:
means for selecting a created information object; and
means for inserting the contents of the selected information object into a specified external application program which is different from the original external application program from which the information object has been obtained.

4. An information fragments editing system according to claim 1, further comprising:
means for selecting a created information object; and
means for moving a position on the window where the selected information object is shown.

5. An information fragments editing system according to claim 1, further comprising:
means for selecting a created information object; and
means for removing the contents and attribute information on the selected information object from said information storing unit and clearing display of the information object on the window.

6. An information fragments editing system according to claim 1, further comprising:
means for selecting a created information object;
means for changing the contents of the selected information object in accordance with an input from outside; and
means for showing the changed information object.

7. An information fragments editing system according to claim 1, further comprising:
means for selecting a created information object;
means for creating a new information object relating to the selected information object in accordance with an input from outside; and
means for showing the newly created information object.

8. An information fragments editing system according to claim 1, further comprising:
means for selecting created information objects;
means for creating a combined information object with which the contents of the selected information objects are combined; and
means for showing the combined information object.

9. An information fragments editing system according to claim 1, further comprising:
means for selecting a created information object;
means for creating separated information objects from which the contents of the selected information object are separated; and
means for showing the separated information objects.

10. An information fragments editing system according to claim 1, further comprising:
means for selecting created information objects; and
means for grouping the selected information objects into one information object group.

11. An information fragments editing system according to claim 10, wherein:
when one information object in the information object group has been selected and the location of the selected information object has been moved, all the other information objects in the information object group are moved in such a manner that the relative location thereof in the information object group is maintained.

12. An information fragments editing system according to claim 10, wherein when one information object in the information object group has been selected and the selected information object has been deleted, all the other information objects in the information object group are also deleted.

13. An information fragments editing system according to claim 10, wherein one information object in the information object group is selected, and the relationship of the selected information object in the information object group is canceled.

14. An information fragments editing system according to claim 10, wherein
two information objects are selected, and a hierarchical relationship is given to the selected information objects to form an information object group.

15. An information fragments editing system according to claim 14, wherein
a master information object or a slave information object belonging to the information object group in which the hierarchical relationship is given is selected, and the selected information object is deleted.

16. An information fragments editing system according to claim 10, wherein
an information object belonging to any one of information object groups and an information object which does not belong to any information object group are shown on the window by different ways.

17. A computer memory product storing a computer program for obtaining information from an external application program and showing the obtained information as an information object, said computer program comprising the steps of:
displaying, on a window displaying information controlled by an external application program, a transparent window through which contents of the information controlled by the external application program is seen, said transparent window detecting a position and a size of said window and having a position and a size being the same as the detected position and size of said window based upon the detecting of the position and size;
analyzing an event for selecting information to be obtained from and to an external application program;
obtaining information from the external application program in accordance with the result of the analysis;
creating an information object in accordance with the obtained information and attribute information, the attribute information including object ID, object type, information type, priority for showing, time stamp, object ID of link-destination object and object ID of a next object, which are able to be modified after being created as an information object; and
showing the information object on said transparent window in accordance with information contents and attribute information relating to display of objects such that the information object appears different from any non-selected information in the external application program,
wherein when the position or the size of said window changes, said transparent window changes the position or the size thereof to be the same as that of said window.

18. A computer memory product according to claim 17, said computer program further comprising the steps of:
selecting a created information object; and
returning the contents of the selected information object to the original external application program from which the information object has been obtained or a specified external application program which is different from the original external application program.

19. A computer memory product according to claim 17, said computer program further comprising the steps of:
selecting a created information object; and
editing the contents of the selected information object.

20. A computer memory product according to claim 19, wherein said editing process includes at least one of processes including a process for moving the location of the information object, a process for deleting the information object, a process for changing the contents of the information object, a process for creating a new information object related to other information object, a process for combining information objects and a process for grouping information objects.

21. A computer memory product having computer readable program code means capable of reading by a computer for obtaining information from an external application program and showing the obtained information as an information object, said computer readable program code means comprising:
program code means for causing the computer to display, on a window displaying information controlled by an external application program, a transparent window through which contents of the information controlled by the external application program is seen, said transparent window having a position and size being a same position and a same size as said window;
program code means for causing the computer to analyze an event for selecting information to be obtained from and to an external application program;
program code means for causing the computer to obtain information from the external application program in accordance with the result of the analysis;
program code means for causing the computer to create an information object in accordance with the obtained information and attribute information, the attribute information including object ID, object type, information type, priority for showing, time stamp, object ID of link-destination object and object ID of a next object, which are able to be modified after being created as an information object; and
program code means for causing the computer to display the information object on said transparent window in accordance with information contents and attribute information relating to display of objects such that the information object appears different from any non-selected information in the external application program,
wherein when the position or the size of said window changes, said transparent window will automatically be changed to have the same position and size as that of said window.

22. A computer memory product according to claim 21, said computer readable program code means further comprising:
program code means for causing the computer to select a created information object; and
program code means for causing the computer to insert the contents of the selected information object into the original external application program from which the information object has been obtained or a specified external application program which is different from the original external application program.

23. A computer memory product according to claim 21, said computer readable program code means further comprising:
program code means for causing the computer to select a created information object; and
program code means for causing the computer to edit the contents of the selected information object.

24. A computer memory product according to claim 23, wherein said program code means for causing the computer to edit the contents of the selected information object comprises at least one of:
program code means including program code means for causing the computer to move the location of the information object,
program code means for causing the computer to delete the information object,
program code means for causing the computer to change the contents of the information object,
program code means for causing the computer to create a new information object related to other information object,
program code means for causing the computer to combine information objects, and program code means for causing the computer to group information objects.

25. A computer readable storage controlling a computer by:
displaying, on a window displaying information controlled by an external application program, a transparent window through which contents of the information controlled by the external application program is seen, said transparent window having a position and size being a same position and a same size as said window;
analyzing an event for selecting information to be obtained from and to an external application program and obtaining information from the external application program in accordance with the result of the analysis;
creating an information object in accordance with the obtained information and attribute information, the attribute information including object ID, object type, information type, priority for showing, time stamp, object ID of link-destination object and object ID of a next object, which are able to be modified after being created as an information object; and
displaying the information object on said transparent window in accordance with information contents and attribute information relating to display of objects,
wherein when the position or the size of said window changes, said transparent window will automatically be changed to have the same position and size as that of said window.

26. (PREVIOUSLY PRESENTED) A computer memory product having computer readable program code capable of reading by a computer for obtaining information from an external application program and showing the obtained information as an information object, said computer readable program code comprising:
code causing the computer to display, on a window displaying information controlled by an external application program, a transparent window through which contents of the information controlled by the external application program is seen, said transparent window having a position and size being a same position and a same size as said window;
code causing the computer to analyze an event for selecting information to be obtained from and to an external application program and to obtain information from the external application program in accordance with the result of the analysis;
code causing the computer to create an information object in accordance with the obtained information and attribute information, the attribute information including object ID, object type, information type, priority for showing, time stamp, object ID of link-destination object and object ID of a next object, which are able to be modified after being created as an information object; and
code for causing the computer to display the information object on the transparent window in accordance with information contents and attribute information relating to display of objects.
wherein when the position or the size of said window changes, said transparent window will automatically be changed to have the same position and size as that of said window.

27. An information fragments editing system for executing an application program for obtaining information from all external application program to show the obtained information as an information object, comprising:
a unit for displaying, on a window displaying information controlled by an external application program, a transparent window through which contents of the information controlled by the external application program is seen, said transparent window having a position and size being a same position and a same size as said window;
an information storing unit storing contents and attribute information of an information object to be shown;
a drawing unit drawing the information object on said transparent window in accordance with the contents and attribute information relating to the display of the object stored in said information storing unit, the drawing unit changing a manner of drawing the information object on the basis of the attribute information;
an event analyzing unit analyzing all the events from and to an operation system and reporting a result of the analysis;
a message transmitting unit transmitting a control message to an external application program in order to get a selected information in the external application program; and
a performing unit performing at least any one of processes including a process of controlling said information storing unit, a process of controlling said message transmitting unit and a process of controlling said drawing unit, in accordance with the result of the analysis reported from said event analyzing unit,
wherein in case that any information in an external application program has been selected and an event for obtaining the selected information has been analyzed by said event analyzing unit, the selected information is created as an information object so as to be shown on said transparent window by said drawing unit such that the information object appears different from any non-selected information in the external application program,
wherein when the position or the size of said window changes, said transparent window will automatically be changed to have the same position and size as that of said window.

28. A method of obtaining information from an external application program and showing the obtained information as an information object, comprising:
displaying, on a window displaying information controlled by the external application program, a transparent window through which contents of the information controlled by the external application program are seen;
detecting a position and a size of the window;
positioning and a sizing the transparent window to have a same position and size as the detected position and size of the window; and
changing the position or the size of the transparent window to be the same as the position and size of the window when the position or the size of the window changes.

29. The method according to claim 28, wherein the changing of the position or the size comprises continuously changing the position or the size when the size of the window changes.
